(19) United States
(12) Patent Application Publication
(10) Pub. No.: US 2025/0211925 A1
(43) Pub. Date: Jun. 26, 2025

(54) SIGNAL PROCESSING METHOD AND ACOUSTIC SYSTEM

(71) Applicant: SHENZHEN SHOKZ CO., LTD., Shenzhen (CN)

(72) Inventors: Chenyang WU, Shenzhen (CN); Le XIAO, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/075,842

(22) Filed: Mar. 11, 2025

Related U.S. Application Data
(63) Continuation of application No. PCT/CN2023/094374, filed on May 15, 2023.

(51) Int. Cl. H04R 25/00

(52) U.S. Cl. CPC H04R 25/505; H04R 25/407; H04R 25/604; H04R 25/609; H04R 2225/41; H04R 2430/01

(57) ABSTRACT

A signal processing method and an acoustic system are provided. The method comprises: obtaining a first signal and a second signal, where the first signal is obtained by a first sound sensor in a sound sensor module during operation to capture an ambient sound, and the second signal is obtained by a second sound sensor in the sound sensor module during operation to capture the ambient sound, the ambient sound comprises at least a target sound emitted by a speaker during operation, performing a first target operation on the first signal and the second signal to reduce pickup of the target sound by the sound sensor module in a target frequency band and attenuate a signal corresponding to the target sound picked up by the sound sensor module, thereby obtaining a target signal, and then performing a second target operation on the target signal.

### RELATED APPLICATIONS

This application is a continuation application of PCT application No. PCT/CN2023/094374, filed on May 15, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of acoustic technology, particularly to a signal processing method and an acoustic system.

### BACKGROUND

Some acoustic systems comprise both a speaker and a sound sensor. In these systems, the ambient sound collected by the sound sensor may comprise sound emitted from the speaker, which is detrimental to the operation of the acoustic system. For example, in a hearing aid system, the sound sensor collects ambient sound during operation, amplifies the gain of the ambient sound, and then plays it through the speaker to compensate for the wearer's hearing loss. When the sound emitted by the speaker is recaptured by the sound sensor, a closed-loop circuit is formed in the acoustic system, causing the sound emitted by the speaker to be continuously amplified in the loop, leading to acoustic feedback, which results in discomfort for the wearer. Additionally, in a telephone system or a conference system, voice signals from a remote user are played through the local speaker and are then collected by the local sound sensor along with the voice from the local user, and transmitted back to the remote end. As a result, the remote user may experience interference from echo.

### SUMMARY

This disclosure provides a signal processing method and acoustic system that can reduce the signal component from the speaker in the target signal, thereby achieving the effect of suppressing feedback or eliminating echo.

In a first aspect, this disclosure provides an acoustic system, comprising: a speaker, configured to receive an input signal and output a target sound during operation; a sound sensor module, comprising at least a first sound sensor and a second sound sensor, where the first sound sensor collects an ambient sound and generates a first signal during operation, the second sound sensor collects the ambient sound and generates a second signal during operation, and the ambient sound comprises at least the target sound; and a signal processing circuit, connected to the sound sensor module to execute, where during operation, the acoustic system performs: obtaining a first signal, obtaining a second signal, performing a first target operation on the first signal and the second signal to reduce pickup of the target sound by the sound sensor module in a target frequency band and attenuate a signal corresponding to the target sound picked up by the sound sensor module, so as to obtain a target signal, and performing a second target operation on the target signal.

In a second aspect, this disclosure provides a signal processing method, comprising, by a signal processing circuit: obtaining a first signal, where the first signal is obtained by a first sound sensor in a sound sensor module during operation to capture an ambient sound, the ambient sound at least comprises a target sound, and the target sound is a sound output by a speaker during operation; obtaining a second signal, where the second signal is obtained by a second sound sensor in the sound sensor module during operation to capture the ambient sound; performing a first target operation on the first signal and the second signal to reduce pickup of the target sound by the sound sensor module in a target frequency band and attenuate a signal corresponding to the target sound picked up by the sound sensor module, so as to obtain a target signal; and performing a second target operation on the target signal.

From the above technical solution, it can be seen that this disclosure provides a signal processing method and an acoustic system. The signal processing method comprises: obtaining a first signal and a second signal, where the first signal is obtained by a first sound sensor in a sound sensor module collecting ambient sound during operation, and the second signal is obtained by a second sound sensor in the sound sensor module collecting ambient sound during operation. The ambient sound comprises at least a target sound emitted by a speaker during operation. A first target operation is performed on the first signal and the second signal to reduce the pickup of the target sound by the sound sensor module in a target frequency band and attenuate the signal corresponding to the target sound picked up by the sound sensor module, thereby obtaining a target signal. Subsequently, a second target operation is performed on the target signal. In the above solution, the first target operation can, on one hand, reduce the pickup of the target sound by the sound sensor module, and on the other hand, attenuate the signal corresponding to the target sound picked up by the sound sensor module, so that the resulting target signal contains no or minimal signal components from the speaker. As a result, the acoustic system can achieve the effect of suppressing howling or eliminating echo.

Other functions of the acoustic system and signal processing method provided in this disclosure will be partially listed in the following description. The inventive aspects of the acoustic system and signal processing method provided in this disclosure can be fully explained through the practice or use of the methods, devices, and combinations described in the detailed examples below.

### BRIEF DESCRIPTION OF THE DRAWINGS

To more clearly illustrate the technical solutions in the embodiments of this disclosure, the drawings required for the description of the embodiments will be briefly introduced below. Obviously, the drawings described below are merely some exemplary embodiments of this disclosure. For a person of ordinary skill in the art, other drawings can also be obtained based on these drawings without any creative effort.

FIG. 1 shows a schematic diagram of a howling scenario provided according to some exemplary embodiments of this disclosure;

FIG. 2 shows a schematic diagram of an echo scenario provided according to some exemplary embodiments of this disclosure;

FIG. 3A shows a schematic structural diagram of an acoustic system provided according to some exemplary embodiments of this disclosure;

FIG. 3B shows a schematic logical diagram of an acoustic system provided according to some exemplary embodiments of this disclosure;

FIG. 4 shows a schematic design diagram of the acoustic system shown in FIG. 3A-3B;

FIG. 5 shows a flowchart of a signal processing method provided according to some exemplary embodiments of this disclosure;

FIG. 6 shows a schematic diagram of a signal processing process provided according to some exemplary embodiments of this disclosure;

FIG. 7 shows a schematic diagram of a signal processing process provided according to some exemplary embodiments of this disclosure;

FIG. 8 shows a schematic diagram of a sound pickup control operation provided according to some exemplary embodiments of this disclosure;

FIG. 9 shows a schematic diagram of a zero differential operation provided according to some exemplary embodiments of this disclosure;

FIG. 10 shows a schematic diagram of the pickup direction pattern corresponding to the zero differential operation in FIG. 9;

FIG. 11 shows a schematic diagram of the frequency response curve of the first differential signal obtained using the zero differential operation shown in FIG. 9;

FIG. 12 shows a schematic diagram of a zero differential operation provided according to some exemplary embodiments of this disclosure;

FIG. 13 shows a schematic diagram of the pickup direction adjustment principle corresponding to the zero differential operation in FIG. 12;

FIG. 14 shows a schematic diagram of the pickup direction patterns of the zero differential operation 41b in FIG. 12 under three different scenarios;

FIG. 15 shows a schematic diagram of a zero differential operation provided according to some exemplary embodiments of this disclosure;

FIG. 16 shows a schematic diagram of the adjustment of the zero sound pickup direction by the target parameter β according to some exemplary embodiments of this disclosure;

FIG. 17 shows a schematic diagram of a sound pickup control operation provided according to some exemplary embodiments of this disclosure;

FIG. 18 shows a schematic diagram of a sound pickup control operation provided according to some exemplary embodiments of this disclosure;

FIG. 19 shows a schematic diagram of the frequency response curves corresponding to a set of complementary filtering operations provided according to some exemplary embodiments of this disclosure;

FIG. 20 shows a schematic diagram of the background noise components corresponding to the differential result signal and the composite signal in FIG. 18, respectively;

FIG. 21 shows a schematic diagram of the zero-point attenuation effects corresponding to different zero differential operations provided according to some exemplary embodiments of this disclosure; and

FIG. 22 shows a schematic diagram of a sound pickup control operation provided according to some exemplary embodiments of this disclosure.

### DETAILED DESCRIPTION

The following description provides specific application scenarios and requirements of this disclosure, with the aim of enabling a person skilled in the art to manufacture and use the content of this disclosure. For a person skilled in the art, various local modifications to the disclosed embodiments are apparent, and the general principles defined here can be applied to other embodiments and applications without departing from the spirit and scope of this disclosure. Therefore, this disclosure is not limited to the embodiments shown but is intended to cover the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them.

For the convenience of description, the terms appearing in this disclosure are first explained below.

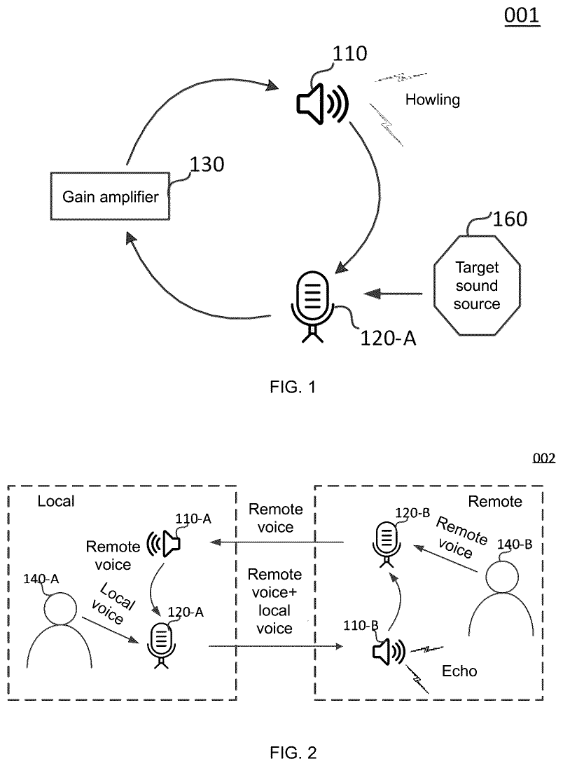

Howling: Howling is a phenomenon that frequently occurs in acoustic systems. The process of howling generation is explained below with reference to FIG. 1. FIG. 1 shows a schematic diagram of a howling scenario 001 provided according to some exemplary embodiments of this disclosure, where the howling scenario 001 may correspond to scenarios such as a public address system, a hearing aid/assistive listening system, etc. As shown in FIG. 1, the howling scenario 001 comprises a speaker 110, a sound sensor 120-A, and a gain amplifier 130. The sound sensor 120-A collects the ambient sound during operation. If the speaker 110 is also playing sound synchronously during this process, the sound played by the speaker 110 will also be picked up by the sound sensor 120-A. Thus, the ambient sound collected by the sound sensor 120-A comprises both the sound from the target sound source 160 and the sound from the speaker 110. Subsequently, the aforementioned ambient sound is input to the gain amplifier 130 for gain amplification and then played through the speaker 110. This forms a closed-loop circuit of “speaker-sound sensor-speaker” in the acoustic system. In this case, when sound signals at certain frequencies undergo self-excited oscillation, the howling phenomenon occurs. Such howling can cause discomfort to users, and when the howling becomes severe, it may even damage the acoustic equipment. Additionally, the presence of howling imposes limitations on the gain amplification factor of the gain amplifier 130, thereby restricting the maximum sound gain that the acoustic system 003 can achieve.

Echo: Echo is also a phenomenon that frequently occurs in acoustic systems. The process of echo generation is explained below with reference to FIG. 2. FIG. 2 shows a schematic diagram of an echo scenario 002 provided according to some exemplary embodiments of this disclosure, where the echo scenario 002 may correspond to scenarios such as a telephone system, a conference system, a voice call system, etc. As shown in FIG. 2, the echo scenario 002 comprises a local end and a remote end. The local end comprises a local user 140-A, a speaker 110-A, and a sound sensor 120-A, while the remote end comprises a remote user 140-B, a speaker 110-B, and a sound sensor 120-B. The local end and the remote end can be connected via a network. The network serves as a medium to provide a communication connection between the local end and the remote end, facilitating the exchange of information or data between the two. In some exemplary embodiments, the network can be any type of wired or wireless network, or a combination thereof. For example, the network may comprise a cable network, a wired network, a fiber optic network, a telecommunication network, an intranet, the Internet, a local area network (LAN), a wide area network (WAN), a wireless local area network (WLAN), a metropolitan area network (MAN), a wide area network (WAN), a public switched telephone network (PSTN), a Bluetooth network, a ZigBee network, a near field communication (NFC) network, or similar networks. In some exemplary embodiments, the network may comprise one or more network access points. For example, the network may comprise wired or wireless network access points, such as base stations or Internet exchange points, through which the local end and the remote end can connect to the network to exchange data or information.

Continuing with reference to FIG. 2, during the call between the local user 140-A and the remote user 140-B, the remote voice emitted by remote user 140-B is collected by sound sensor 120-B and transmitted to the local end, then played through the local speaker 110-A. The remote voice played by speaker 110-A, along with the local voice emitted by local user 140-A, is collected by the sound sensor 120-A at the local end and then transmitted back to the remote end, where it is played through the remote speaker 110-B. In this way, remote user 140-B will hear his or her echo, thus being disturbed by the echo. It should be noted that FIG. 2 shows the process in which remote user 140-B is disturbed by the echo. It should be understood that the local user 140-A may also be disturbed by the echo, and the process of echo generation at the local end is similar to the one described above, which will not be elaborated further herein. This kind of echo can interfere with the normal conversation of the users.

Background noise: Refers to the surrounding ambient sound other than the sound source being measured. In this disclosure, any sound that is unwanted by the user, undesired by the user, or interferes with the user's hearing can be called noise.

Sound pickup direction pattern: Refers to a pattern used to represent the sensitivity of the sound sensor/sound sensor module to sounds from different directions. In simple terms, the sound pickup direction pattern can represent the ability of the sound sensor/sound sensor module to pick up sounds from different directions. Typically, the sound pickup direction pattern can comprise: omnidirectional, heart-shaped, number 8 shaped, super-cardioid-shaped, etc.

Zero sound pickup direction: Theoretically, if the sound sensor/sound sensor module has a sensitivity to sound from a certain direction of 0 or close to 0, that direction is referred to as the zero sound pickup direction. It should be understood that when the sound source is located at the zero sound pickup direction, the sound sensor/sound sensor module will theoretically not capture any sound emitted by the sound source. In practice, due to manufacturing errors of the sound sensor/sound sensing module and the fact that sound sources in reality are not necessarily ideal point sources, the sound sensor/sound sensing module may still capture a small amount of sound from the zero sound pickup direction. It should be noted that in this disclosure, the zero sound pickup direction can refer to a specific direction or to a range of directions that comprises multiple directions.

Far-field sound source: Refers to a sound source that is relatively far from the sound sensor/sound sensor module. Generally speaking, when the distance between the sound source to be measured and the sound sensor/sound sensor module is greater than N times the physical size of the sound sensor/sound sensor module, the sound source can be approximated as a far-field sound source. It should be noted that in different application scenarios, the value of N can vary. For example, in the case of headphones, the physical size of the sound sensor/sound sensor module may be less than or equal to 0.01 m, and at this time, the value of N can be greater than or equal to 10. This means that a sound source located at a distance greater than or equal to 0.1 m from the sound sensor/sound sensor module can be considered a far-field sound source. Compared to a near-field sound source, the sound waves from the far-field sound source are approximately planar, and the amplitude of the sound waves decreases less as they propagate.

Near-field sound source: Refers to a sound source that is relatively close to the sound sensor/sound sensor module. Generally speaking, when the distance between the sound source to be measured and the sound sensor/sound sensor module is less than 2 to 3 times the physical size of the sound sensor/sound sensor module, the sound source can be approximated as a near-field sound source. For example, in the case of headphones, a sound source at a distance less than 0.1 m can be considered a near-field sound source. Compared to the aforementioned far-field sound source, the sound waves from the near-field sound source are closer to spherical, and the amplitude of the sound waves decreases more significantly as they propagate.

Before describing the specific embodiments of this disclosure, the application scenarios of this disclosure are introduced as follows: The signal processing method and acoustic system provided in this disclosure can be applied to scenarios that require squeal suppression (such as the scenario shown in FIG. 1) and scenarios that require echo cancellation (such as the scenario shown in FIG. 2). In the aforementioned scenarios, the acoustic system collects ambient sound through the sound sensor module and uses the signal processing method described in this disclosure to process the collected signals to generate target signals, so as to reduce the signal components from the speaker in the target signals, thereby achieving the purposes of squeal suppression or echo cancellation.

It should be noted that the squeal suppression scenario and the echo cancellation scenario are just some of the various application scenarios provided in this disclosure. The signal processing method and acoustic system provided in this disclosure can also be applied to other similar scenarios. A person skilled in the art should understand that the signal processing method and acoustic system provided in this disclosure applied to other usage scenarios are also within the scope of protection of this disclosure.

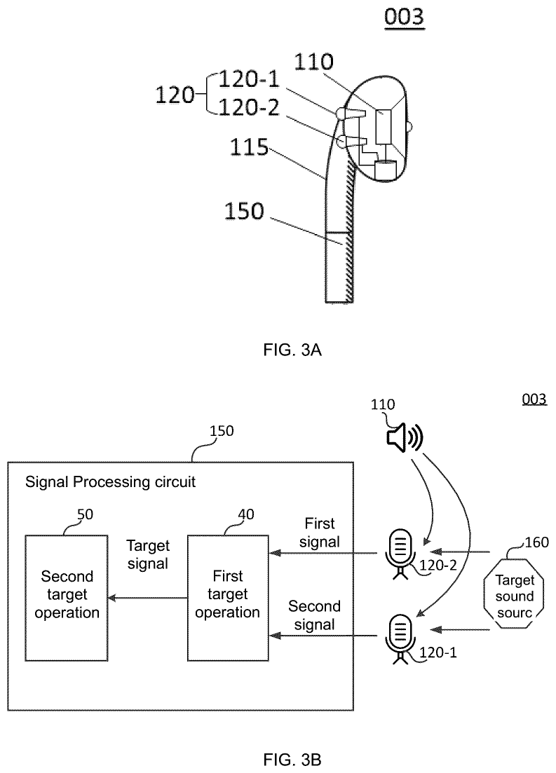

FIG. 3A shows a schematic diagram of the structure of an acoustic system 003 according to some exemplary embodiments of this disclosure; FIG. 3B shows a schematic diagram of the logic of the acoustic system 003 according to some exemplary embodiments of this disclosure. The acoustic system 003 can be an amplification system, a hearing/assistive listening system, a telephone system, a conference system, or a voice communication system, etc. As shown in FIG. 3A-3B, the acoustic system 003 can comprise: a speaker 110, a sound sensor module 120, and a signal processing circuit 150. The sound sensor module 120 comprises at least a first sound sensor 120-1 and a second sound sensor 120-2.

It should be noted that in the acoustic system 003 shown in FIG. 3A-3B, the physical positional relationship between the speaker 110, the first sound sensor 120-1, and the second sound sensor 120-2 can be arbitrary, and the physical positional relationship between the three is not displayed in FIG. 3A-3B. For example, in some exemplary embodiments, the speaker 110, the first sound sensor 120-1, and the second sound sensor 120-2 can be arranged in a straight line. In another example, in some exemplary embodiments, the speaker 110 can be located (or approximately located) on the perpendicular bisector of the first sound sensor 120-1 and the second sound sensor 120-2. In this case, the distance between the speaker 110 and the first sound sensor 120-1 and the distance between the speaker 110 and the second sound sensor 120-2 are equal (or approximately equal). Of course, the physical positional relationship between the speaker 110, the first sound sensor 120-1, and the second sound sensor 120-2 can also be other arrangements, which are not individually listed in this disclosure.

In some exemplary embodiments, the acoustic system 003 is a hearing system, and the acoustic system 003 may also comprise a housing, with the speaker 110, the sound sensor module 120, and the signal processing circuit 150 being disposed inside the housing. The housing serves to protect the internal components and makes it convenient for the user to handle and wear. The acoustic system 003 can be worn on the user's head. For example, the acoustic system 003 can be worn in the ear or over the ear at the user's ear region. When the acoustic system 003 is worn on the user's head, the sound-emitting end of the speaker 110 is oriented towards the user's head, for example, towards the user's ear canal opening or near the ear canal opening. The pickup end of at least one sound sensor in the sound sensor module 120 is located on the side of the housing away from the user's head. In this way, on one hand, it facilitates the pickup of ambient sound, and on the other hand, it can minimize the pickup of sound emitted by the speaker 110.

The first sound sensor 120-1 and the second sound sensor 120-2 can be the same sound sensor or different sound sensors. For ease of description, in this disclosure, the sound sensor in the sound sensor module 120 that is closer to the speaker 110 is referred to as the second sound sensor 120-2, while the sound sensor farther from the speaker 110 is referred to as the first sound sensor 120-1. That is to say, the second sound sensor 120-2 is closer to the speaker 110 compared to the first sound sensor 120-1. In this way, the sound emitted by the speaker 110 will first be captured by the second sound sensor 120-2 and then by the first sound sensor 120-1. In this case, the phase of the signal component corresponding to the target sound in the second signal is earlier than the phase of the signal component corresponding to the target sound in the first signal. When the distances between the two sound sensors and the speaker 110 are equal, either one can be referred to as the first sound sensor 120-1, and the other as the second sound sensor 120-2. In this case, the phase of the signal component corresponding to the target sound in the second signal is equal to the phase of the signal component corresponding to the target sound in the first signal. Additionally, the speaker 110, the first sound sensor 120-1, and the second sound sensor 120-2 can be integrated into the same electronic device or can be independent of each other, and this disclosure does not impose any limitations on this.

The speaker 110 can also be referred to as an electroacoustic transducer, a device used to convert electrical signals into sound signals. For example, the speaker 110 can be a loudspeaker. When operating, the speaker 110 receives an input signal and converts it into audio for playback. Here, the aforementioned input signal refers to an electrical signal carrying sound information, and the aforementioned audio refers to the sound played through the speaker 110. In some exemplary embodiments, the input signal received by the speaker 110 may come from the sound sensor module 120. This situation may correspond to the acoustic scenario shown in FIG. 1. For instance, after the sound sensor module 120 captures ambient sound and generates an electrical signal, it provides the electrical signal to the speaker 110 for playback, or it preprocesses the electrical signal and then provides it to the speaker 110 for playback. The aforementioned preprocessing may comprise at least one of amplification processing, noise reduction processing, or enhancement processing. In some exemplary embodiments, the input signal received by the speaker 110 may also come from other electronic devices. This situation may correspond to the acoustic scenario shown in FIG. 2. For example, the acoustic system 003 can receive an input signal from a remote device, convert the input signal into audio through the speaker 110 for playback, or preprocess the input signal and then convert it into audio through the speaker 110 for playback. The aforementioned preprocessing may comprise at least one of amplification processing, noise reduction processing, or enhancement processing. In some exemplary embodiments, the acoustic system 003 may comprise multiple speakers 110. In this case, the multiple speakers 110 can be arranged in an array, such as a linear array, planar array, spherical array, or other types of arrays.

The sound sensor (first sound sensor 120-1 and/or second sound sensor 120-2) can also be referred to as an acoustic-electric transducer or a sound pickup device, which is a device used to capture sound and convert it into an electrical signal. For example, a sound sensor can be a microphone (Microphone, MIC). When operating, the sound sensor captures ambient sound and converts it into an electrical signal carrying sound information. The sound sensor can be an omnidirectional sound sensor, in which case it can capture ambient sound from all directions. The sound sensor can also be a directional sound sensor, in which case it can capture ambient sound from specific directions.

Continuing to refer to FIG. 3A-3B, in some exemplary embodiments, the acoustic system 003 can perceive and process sound from a target sound source 160. For example, the target sound source 160 can be an electronic device with sound playback capabilities (such as a television, speaker, mobile phone, etc.), or, for instance, the target sound source 160 can also be a human throat. In this case, the ambient sound comprises both sounds from the target sound source 160 and sound from the speaker 110. When the first sound sensor 120-1 operates, it captures the ambient sound and generates a first signal, which comprises the sound signal from the target sound source 160 and the sound signal from the speaker 110. When the second sound sensor 120-2 operates, it captures the ambient sound and generates a second signal, which comprises the sound signal from the target sound source 160 and the sound signal from the speaker 110. For ease of description, this disclosure refers to the sound emitted by the speaker 110 as the target sound. Thus, the ambient sound comprises at least the target sound, the first signal comprises at least a signal corresponding to the target sound, and the second signal comprises at least a signal corresponding to the target sound.

The signal processing circuit 150 is connected to the sound sensor module 120, as shown in FIG. 3A-3B, with the signal processing circuit 150 being separately connected to the first sound sensor 120-1 and the second sound sensor 120-2. In this way, the signal processing circuit 150 can obtain the first signal from the first sound sensor 120-1 and the second signal from the second sound sensor 120-2. Furthermore, the signal processing circuit 150 can perform a first target operation 40 on the first signal and the second signal to reduce the sound sensor module 120's pickup of the target sound in the target frequency band and attenuate the signal corresponding to the target sound picked up by the sound sensor module 120, thereby obtaining a target signal. It should be understood that since the first target operation 40 can reduce the sound sensor module 120's pickup of the target sound in the target frequency band and attenuate the signal corresponding to the target sound picked up by the sound sensor module 120, the signal processing circuit 150, by executing the first target operation 40, can reduce the signal component from the speaker 110 in the target signal. In some exemplary embodiments, “reducing the signal component from the speaker 110 in the target signal” refers to reducing the signal component from the speaker 110 in the target signal relative to the first signal and/or the second signal. That is, the signal component from the speaker 110 in the target signal is less than the signal component from the speaker 110 in the first signal, and/or less than the signal component from the speaker 110 in the second signal. In some exemplary embodiments, “reducing the signal component from the speaker 110 in the target signal” may refer to reducing the signal strength from the speaker 110 in the target signal relative to the first signal and/or the second signal. That is, the signal strength from the speaker 110 in the target signal is less than the signal strength from the speaker 110 in the first signal, and/or less than the signal strength from the speaker 110 in the second signal.

Continuing to refer to FIG. 3A-3B, after generating the target signal, the signal processing circuit 150 can perform a second target operation 50 on the target signal. In some exemplary embodiments, the second target operation 50 may comprise: performing gain amplification on the target signal and sending the gain-amplified signal (i.e., the input signal for the speaker 110) to the speaker 110, so that the speaker 110 converts it into the target sound. The above scheme can be applied to the howling suppression scenario shown in FIG. 1. It should be understood that since the signal processing circuit 150 reduces the sound sensor module 120's pickup of the target sound and attenuates the signal corresponding to the target sound picked up by the sound sensor module 120, the signal component from the speaker 110 in the target signal is reduced (or the signal strength from the speaker 110 is lowered), disrupting the conditions under which the sound emitted by the speaker 110 would generate howling in the closed-loop circuit shown in FIG. 1, thereby achieving the effect of suppressing howling.

In some exemplary embodiments, when the speaker 110, the sound sensor module 120, and the signal processing circuit 150 are deployed in a first acoustic device, the first acoustic device can be communicatively connected to a second acoustic device. In this case, the second target operation 50 may comprise: sending the target signal to the second acoustic device to reduce echo in the second acoustic device. The above scheme can be applied to the echo cancellation scenario shown in FIG. 2. For example, the first acoustic device can be a local device, and the second acoustic device can be a remote device. Since the target signal sent from the first acoustic device to the second acoustic device has a reduced signal component from the speaker (or reduced signal strength from the speaker), it effectively eliminates/reduces the sound originating from the second acoustic device. Therefore, when the second acoustic device receives the target signal and plays it back, the user on the second acoustic device side (i.e., the remote user) will not hear an echo, thereby achieving the effect of echo cancellation.

The signal processing circuit 150 can be configured to execute the signal processing method described in this disclosure. In some exemplary embodiments, the signal processing circuit 150 may comprise multiple hardware circuits with interconnection relationships, each hardware circuit comprising one or more electrical components, which, during operation, implement one or more steps of the signal processing method described in this disclosure. These multiple hardware circuits cooperate with each other during operation to realize the signal processing method described in this disclosure. In some exemplary embodiments, the signal processing circuit 150 may comprise hardware equipment with data information processing capabilities and the necessary programs required to drive the operation of this hardware equipment. The hardware equipment executes these programs to implement the signal processing method described in this disclosure. The signal processing method will be described in detail in the following sections.

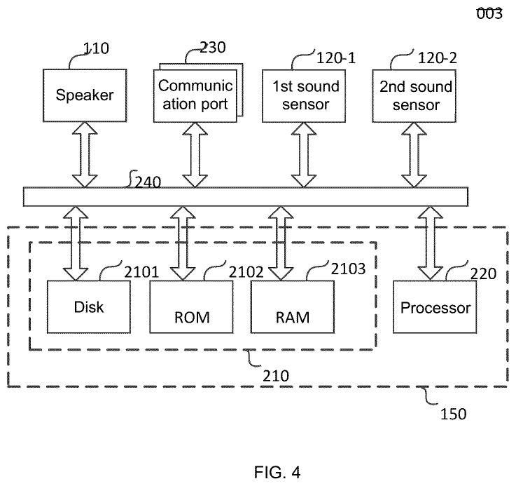

FIG. 4 shows a schematic design diagram of acoustic system 003. As shown in FIG. 4, the signal processing circuit 150 may comprise: at least one storage medium 210 and at least one processor 220. The at least one processor 220 is communicatively connected to the speaker 110, the first sound sensor 120-1, and the second sound sensor 120-2. It should be noted that, for the purpose of illustration only, the signal processing circuit 150 in this disclosure comprises at least one storage medium 210 and at least one processor 220. A person of ordinary skill in the art can understand that the signal processing circuit 150 may also comprise other hardware circuit structures, which are not limited in this disclosure, as long as they can satisfy the functions mentioned in this disclosure without departing from the spirit of this disclosure.

Continuing to refer to FIG. 4, in some exemplary embodiments, the acoustic system 003 may further comprise a communication port 230. The communication port 230 is used for data communication between the acoustic system and the outside world. For example, the communication port 230 can be used for data communication between the acoustic system and other devices/systems. In some exemplary embodiments, the acoustic system 003 may further comprise an internal communication bus 240. The internal communication bus 240 can connect different system components. For example, the speaker 110, the first sound sensor 120-1, the second sound sensor 120-2, the processor 220, the storage medium 210, and the communication port 230 can all be connected via the internal communication bus 240.

The storage medium 210 may comprise a data storage device. The data storage device can be a non-transitory storage medium or a transitory storage medium. For example, the data storage device may comprise one or more of a magnetic disk 2101, a read-only storage medium (ROM) 2102, or a random access storage medium (RAM) 2103. The storage medium 210 also comprises at least one instruction set stored in the data storage device. The instruction set comprises instructions, which are computer program code. The computer program code may comprise programs, routines, objects, components, data structures, procedures, modules, etc., for executing the signal processing method provided in this disclosure.

The at least one processor 220 is configured to execute the aforementioned at least one instruction set. When the acoustic system 003 is running, the at least one processor 220 reads the at least one instruction set and, according to the instructions of the at least one instruction set, executes the signal processing method provided in this disclosure. The processor 220 can perform all or part of the steps included in the aforementioned signal processing method. The processor 220 may be in the form of one or more processors. In some exemplary embodiments, the processor 220 may comprise one or more hardware processors, such as a microcontroller, microprocessor, reduced instruction set computer (RISC), application-specific integrated circuit (ASIC), application-specific instruction set processor (ASIP), central processing unit (CPU), graphics processing unit (GPU), physics processing unit (PPU), microcontroller unit, digital signal processor (DSP), field-programmable gate array (FPGA), advanced RISC machine (ARM), programmable logic device (PLD), any circuit or processor capable of executing one or more functions, or any combination thereof. For illustrative purposes only, the acoustic system 003 shown in FIG. 4 exemplifies a case with only one processor 220. However, it should be noted that the acoustic system 003 provided in this disclosure may also comprise multiple processors. Therefore, the operations and/or method steps disclosed in this disclosure may be performed by a single processor or jointly performed by multiple processors. For example, if the processor 220 of the acoustic system in this disclosure performs step A and step B, it should be understood that step A and step B may also be performed jointly or separately by two different processors 220 (e.g., a first processor performs step A, a second processor performs step B, or the first and second processors jointly perform steps A and B).

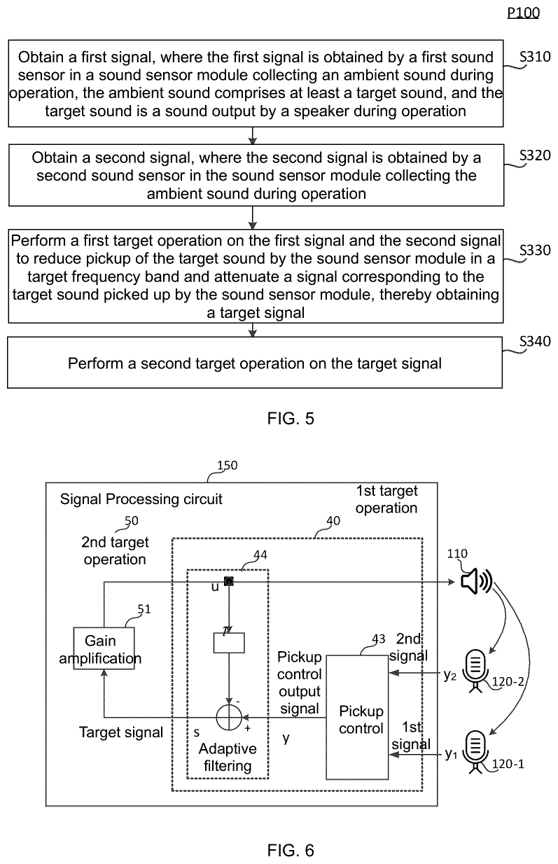

FIG. 5 shows a flowchart of a signal processing method provided according to some exemplary embodiments of this disclosure. The signal processing method P100 described in this disclosure can be applied to the acoustic system 003 as described earlier. Specifically, the signal processing circuit 150 can execute the signal processing method P100. As shown in FIG. 5, the signal processing method P100 may comprise:

S310: Obtain a first signal, where the first signal is obtained by a first sound sensor in a sound sensor module collecting an ambient sound during operation, the ambient sound comprises at least a target sound, and the target sound is a sound output by a speaker during operation.

S320: Obtain a second signal, where the second signal is obtained by a second sound sensor in the sound sensor module collecting the ambient sound during operation.

The signal processing circuit 150 can obtain the first signal from the first sound sensor 120-1 and the second signal from the second sound sensor 120-2. As mentioned earlier, since the ambient sound comprises both the sound emitted by the target sound source 160 and the target sound emitted by the speaker 110, the first signal and the second signal obtained by the signal processing circuit 150 both contain signal components from the target sound source 160 as well as signal components from the speaker 110.

It should be noted that this disclosure does not impose any restrictions on the execution order of S310 and S320. The order of execution of the two can be interchangeable, or they can also be executed simultaneously.

S330: Perform a first target operation on the first signal and the second signal to reduce pickup of the target sound by the sound sensor module in a target frequency band and attenuate a signal corresponding to the target sound picked up by the sound sensor module, thereby obtaining a target signal.

The signal processing circuit 150 can generate a target signal by performing a first target operation 40 on the first signal and the second signal. The first target operation 40 can serve the following two purposes:

On the one hand, by performing the first target operation 40 on the first signal and the second signal, the signal processing circuit 150 can reduce the pickup of the target sound (i.e., the sound from the speaker 110) by the sound sensor module 120 in a target frequency band. Herein, that “reduce the pickup of the target sound by the sound sensor module in the target frequency band” means that, compared to the pickup of the target sound by the sound sensor module 120 without performing the first target operation 40, the pickup of the target sound by the sound sensor module 120 is reduced when the first target operation 40 is performed.

In some exemplary embodiments, the aforementioned first target operation 40 can direct the zero sound pickup direction of the sound sensor module 120 in the target frequency band toward the speaker. The phrase “zero sound pickup direction directed toward the speaker” should be understood as the zero sound pickup direction generally pointing toward the speaker. For example, the zero sound pickup direction may point to the center point of the speaker. Alternatively, the zero sound pickup direction may point to any point on the sound output surface of the speaker. As another example, the zero sound pickup direction may point to a preset area on the sound output surface of the speaker. For yet another example, assuming the directional angle corresponding to the center point of the speaker is θ, the directional angle corresponding to the zero sound pickup direction may fall within the range θ−Δφ, θ+Δφ. It should be understood that when the zero sound pickup direction of the sound sensor module 120 is directed toward the speaker, the sound emitted by the speaker is either not picked up by the sound sensor module 120 or is picked up to a lesser extent. Therefore, by directing the zero sound pickup direction of the sound sensor module 120 in the target frequency band toward the speaker, the signal processing circuit 150 can reduce the pickup of the target sound by the sound sensor module 120.

It should be noted that the aforementioned target frequency band can be either a full frequency band or a partial frequency band. For example, the full frequency band may refer to the sound pickup frequency band of the sound sensor module, while the partial frequency band may refer to a specific sub-frequency band within the sound pickup frequency band of the sound sensor module. Here, the sound pickup frequency band refers to the range of frequency bands supported by the sound sensor module for picking up sound during operation. It should also be noted that when the target frequency band is a partial frequency band, the target frequency band can correspond to any sub-frequency band within the sound pickup frequency band of the sound sensor module. For instance, it may correspond to a high-frequency sub-band within the sound pickup frequency band, a low-frequency sub-band within the sound pickup frequency band, or a mid-frequency sub-band within the sound pickup frequency band, among others.

On the other hand, the signal processing circuit 150 can also attenuate the signal corresponding to the target sound picked up by the sound sensor module 120 by performing the first target operation 40 on the first signal and the second signal. Here, “signal corresponding to the target sound” refers to the signal component picked up by the sound sensor module 120 from the speaker. In some exemplary embodiments, the signal processing circuit 150 can attenuate the signal corresponding to the target sound picked up by the sound sensor module 120 by filtering the signal picked up by the sound sensor module 120. It is not difficult to understand that by attenuating the signal picked up by the sound sensor module 120, the signal processing circuit 150 can reduce the signal component from the speaker 110 in the target signal.

As can be seen, the first target operation 40 can, on one hand, minimize the pickup of the target sound by the sound sensor module 120 (that is, to make the sound sensor module 120 pick up as little as possible or none of the sound emitted by the speaker), and on the other hand, can attenuate the signal corresponding to the target sound picked up by the sound sensor module 120. By combining the effects of these two aspects, the signal processing circuit 150 can minimize the signal component from the speaker in the target signal.

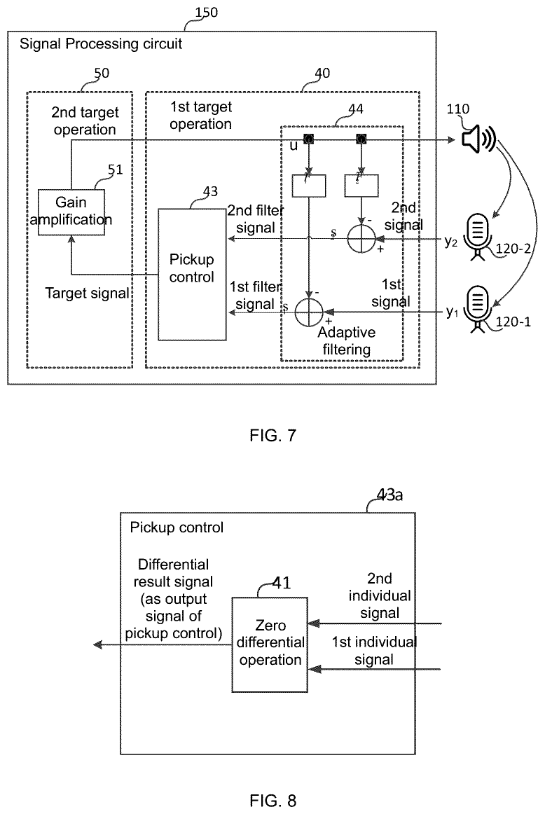

FIG. 6 shows a schematic diagram of a signal processing process provided according to some exemplary embodiments of this disclosure, and FIG. 7 shows a schematic diagram of another signal processing process provided according to some exemplary embodiments of this disclosure. As shown in FIGS. 6 and 7, the first target operation 40 may comprise a sound pickup control operation 43 and an adaptive filtering operation 44. The sound pickup control operation 43 is configured to point the zero sound pickup direction of the sound sensor module 120 in the target frequency band toward the speaker to reduce the pickup of the target sound by the sound sensor module 120. The adaptive filtering operation 44 is configured to attenuate the signal corresponding to the target sound picked up by the sound sensor module 120. In some exemplary embodiments, the adaptive filtering operation 44 can adaptively attenuate the signal from speaker 110 from the signal picked up by the sound sensor module 120 based on the input signal of speaker 110, in which case, the above adaptive filtering operation 44 can be implemented through an Adaptive Feedback Cancellation (AFC) algorithm.

In some exemplary embodiments, the above sound pickup control operation 43 and/or adaptive filtering operation 44 can be implemented by the processor 220 in the signal processing circuit 150, that is, the processor 220 executes the instruction set and performs the sound pickup control operation 43 and/or adaptive filtering operation 44 according to the instructions of the instruction set. In some exemplary embodiments, the signal processing circuit 150 may comprise a sound pickup control circuit, and the above sound pickup control operation 43 can be implemented through the sound pickup control circuit. In some exemplary embodiments, the signal processing circuit 150 may comprise an adaptive filtering circuit, and the above adaptive filtering operation 44 can be implemented through the adaptive filtering circuit.

In some exemplary embodiments, as shown in FIG. 6, the signal processing circuit 150 can first execute the sound pickup control operation 43 and then execute the adaptive filtering operation 44. Specifically, the process of the signal processing circuit 150 executing the first target operation 40 may comprise:

(1) Perform sound pickup control operation 43 on the first signal and the second signal to point the zero sound pickup direction of the sound sensor module 120 in the target frequency band toward the speaker, thereby obtaining a sound pickup control output signal.

By executing the sound pickup control operation 43, the signal processing circuit 150 can adjust the zero sound pickup direction of the sound sensor module 120 in the target frequency band to point toward the speaker 110. In this case, the single-channel signal picked up by the sound sensor module 120 is called the sound pickup control output signal. It should be understood that when the zero sound pickup direction of the sound sensor module 120 in the target frequency band points toward speaker 110, the sound sensor module 120 can reduce the pickup of the target sound in the target frequency band; therefore, the sound pickup control output signal contains less signal component from speaker 110. It should be noted that the specific implementation method of the sound pickup control operation 43 will be described in detail later, and will not be repeated herein.

(2) Obtain the input signal of the speaker, and perform adaptive filtering operation 44 on the sound pickup control output signal based on the input signal to obtain the target signal.

Since the target sound is emitted by speaker 110 based on the input signal, the signal processing circuit 150 can predict how the sound sensor module 120 picks up the target sound based on the input signal, and then perform adaptive filtering on the sound pickup control output signal based on the pickup situation to obtain the target signal. This further reduces the signal component from speaker 110 in the target signal.

In some exemplary embodiments, continuing to refer to FIG. 6, the process of the signal processing circuit 150 executing the adaptive filtering operation 44 may comprise: providing a target gain (\hat{F}) to the input signal to obtain a third signal (i.e., the signal corresponding to the target sound), and subtracting the third signal from the sound pickup control output signal to obtain the target signal. For example, assuming the input signal is, and the sound pickup control output signal is, then the target signal can be expressed by the following formula:

$$s = y - u * \hat{F} \qquad Formula ( 1 )$$

Where the target gain corresponds to the transfer function between speaker 110 and sound sensor module 120; assuming the transfer function between speaker 110 and sound sensor module 120 is F, the signal processing circuit 150 can predict the transfer function F to obtain a predicted transfer function, and determine the predicted transfer function as the target gain F. In this way, providing the target gain to the input signal can simulate how the target sound is picked up by the sound sensor module 120. Furthermore, considering the influence of factors such as environment and user actions, the transfer function F between speaker 110 and sound sensor module 120 is constantly changing. Therefore, in some exemplary embodiments, a preset algorithm can be used to adaptively update the target gain \hat{F}, making the target gain \hat{F} continuously track the transfer function F (i.e., the target gain changes with changes in transfer function F). This makes the third signal (u*\hat{F}) obtained based on the input signal u and the target gain \hat{F} more accurate, that is, the third signal (u*\hat{F}) can more accurately characterize how the sound sensor module 120 picks up the target sound. It should be noted that this disclosure does not limit the preset algorithm, for example, it can use algorithms such as Least Mean Square (LMS), Normalized Least Mean Square (NLMS), Recursive Least Square (RLS), etc.

In some exemplary embodiments, as shown in FIG. 7, the signal processing circuit 150 may first perform the adaptive filtering operation 44, and then perform the sound pickup control operation 43. Specifically, the process of signal processing circuit 150 performing the first target operation 40 may comprise:

(1) obtaining the input signal of the speaker, and based on the input signal, performing the adaptive filtering operation 44 on the first signal and the second signal to obtain a first filtered signal corresponding to the first signal and a second filtered signal corresponding to the second signal. Since the target sound is emitted by the speaker 110 based on the input signal, the signal processing circuit 150 can predict the pickup condition of the first sound sensor 120-1 and the second sound sensor 120-2 for the target sound based on the input signal, and then perform adaptive filtering on the first signal and the second signal based on the pickup condition to obtain the first filtered signal and the second filtered signal. That is, the first filtered signal can be regarded as the signal obtained by attenuating the signal component from the speaker 110 in the first signal, and the second filtered signal can be regarded as the signal obtained by attenuating the signal component from the speaker 110 in the second signal. Therefore, the signal components from the speaker 110 contained in the first filtered signal and the second filtered signal are reduced.

In some exemplary embodiments, continuing with reference to FIG. 7, the process of the signal processing circuit 150 performing the adaptive filtering operation 44 may comprise: providing a first target gain ( [symbol] ) to the input signal to obtain a fourth signal, and subtracting the fourth signal from the first signal to obtain the first filtered signal, as well as providing a second target gain ( [symbol] ) to the input signal to obtain a fifth signal, and subtracting the fifth signal from the second signal to obtain the second filtered signal. For example, assuming the input signal is u, the first signal is y₁, and the second signal is y₂, then the first filtered signal s₁ and the second filtered signal s₂ can be represented by the following formulas:

$${s}_{1} = {y}_{1} - u * \hat{{F}_{1}} \qquad Formula ( 2 )$$

$${s}_{2} = {y}_{2} - u * {\hat{F}}_{2} \qquad Formula ( 3 )$$

Where, the first target gain ( [symbol] ) corresponds to the transfer function between the speaker 110 and the first sound sensor 120-1, and the second target gain ( [symbol] ) corresponds to the transfer function between the speaker 110 and the second sound sensor 120-2. It should be understood that the method of determining the first target gain ( [symbol] ) and the second target gain ( [symbol] ) is similar to the method of determining the target gain (\hat{F}), which will not be elaborated herein.

(2) Perform the sound pickup control operation 43 on the first filtered signal and the second filtered signal to obtain the target signal.

The signal processing circuit 150, by performing the sound pickup control operation 43 on the first filtered signal and the second filtered signal, can adjust the zero sound pickup direction of the sound sensor module 120 in the target frequency band to point toward the speaker 110. It should be understood that when the zero sound pickup direction of the sound sensor module 120 in the target frequency band points toward the speaker 110, the sound sensor module 120 is able to reduce the pickup of the target signal in the target frequency band, thereby further reducing the signal components from the speaker 110 contained in the target signal.

The specific implementation of the adaptive filtering operation 44 is shown in FIGS. 6 and 7, while the implementation of the sound pickup control operation 43 is not shown. The following will provide a detailed explanation of the specific implementation of the sound pickup control operation 43 with reference to FIGS. 8 to 22. It should be understood that any of the sound pickup control operations 43 described below can be applied both in FIG. 6 and in FIG. 7.

FIG. 8 shows a schematic diagram of a sound pickup control operation 43a provided according to some exemplary embodiments of the present application. As shown in FIG. 8, the sound pickup control operation 43a may comprise a zero differential operation 41, which is configured to perform a zero differential on the first body signal and the second body signal to adjust the zero sound pickup direction of the sound sensor module 120 to point toward the speaker 110, thereby obtaining a differential result signal. The first body signal and the second body signal are the two input signals of the sound pickup control operation 43a. The first body signal corresponds to the pickup signal of the first sound sensor 120-1, for example, it can be the raw signal picked up by the first sound sensor 120-1, or it can be a signal after preset processing of the raw signal. The second body signal corresponds to the pickup signal of the second sound sensor 120-2, for example, it can be the raw signal picked up by the second sound sensor 120-2, or it can be a signal after preset processing of the raw signal. In some exemplary embodiments, when the sound pickup control operation 43a is applied in FIG. 6, the first body signal may be the first signal, and the second body signal may be the second signal. In some exemplary embodiments, when the sound pickup control operation 43a is applied in FIG. 7, the first body signal may be the first filtered signal, and the second body signal may be the second filtered signal. The differential result signal is the output signal of the sound pickup control operation 43a. The term “zero differential” refers to the differential operation that can adjust the zero sound pickup direction of the sound sensor module 120. It should be noted that the present application does not limit the specific method of the differential operation, as long as it can achieve the adjustment of the zero sound pickup direction of the sound sensor module 120.

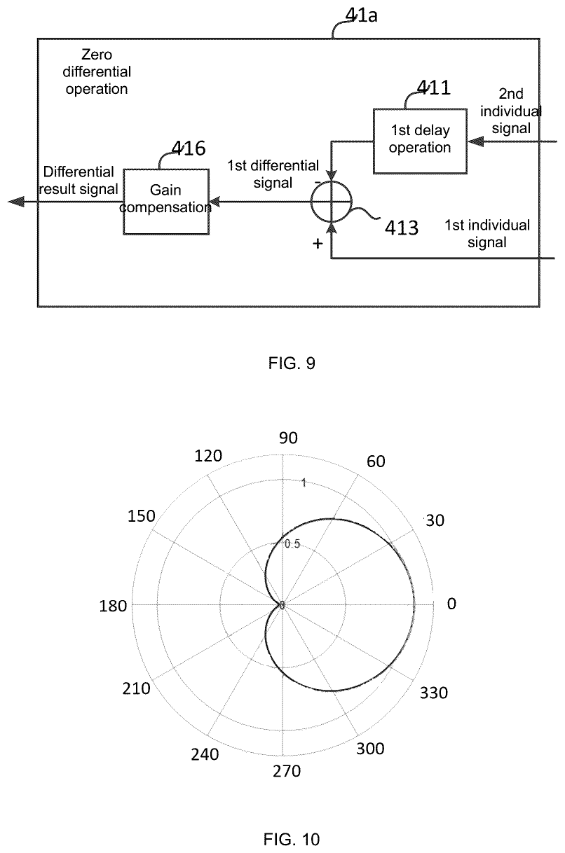

FIG. 9 shows a schematic diagram of a zero differential operation 41a provided according to some exemplary embodiments of the present application. As shown in FIG. 9, the zero differential operation 41a may comprise: a first delay operation 411 and a first differential operation 413. The first delay operation 411 is configured to delay the second body signal to obtain a second delayed signal. The first differential operation 413 is configured to perform a differential between the first body signal and the second delayed signal (for example, subtracting the second delayed signal from the first body signal) to obtain a first differential signal.

The zero differential operation 41a shown in FIG. 9 can be applied in a scenario where the speaker 110 is a far-field sound source. In this scenario, the distance between the speaker 110 and the sound sensor module 120 is relatively large, and it can be assumed that the amplitude and direction of the sound signals acquired by the two sound sensors are the same, with only a time difference (i.e., phase difference) between them. In this case, when the second sound sensor 120-2 is closer to the speaker 110 than the first sound sensor 120-1, the sound emitted by the speaker 110 is first picked up by the second sound sensor 120-2 and then by the first sound sensor 120-1. That is, the phase of the signal component from the speaker 110 in the second body signal precedes the phase of the signal component from the speaker 110 in the first body signal. Therefore, the signal processing circuit 150, by performing the above-mentioned first delay operation 411 (i.e., delaying the second body signal to obtain the second delayed signal), can align the phase of the signal component from the speaker 110 in the second delayed signal with the phase of the signal component from the speaker 110 in the first body signal.

In some exemplary embodiments, when the signal processing circuit 150 performs the first delay operation 411, it can determine the delay duration T corresponding to the second body signal based on the following formula (4):

$$T = d / c \qquad Formula ( 4 )$$

Where, d is the distance between the first sound sensor 120-1 and the second sound sensor 120-2, and c is the speed of sound.

After performing the first delay operation 411, since the phases of the signal components from the speaker 110 in the second delayed signal and the first body signal have been aligned, the signal processing circuit 150, by performing the first differential operation 413 (i.e., subtracting the second delayed signal from the first body signal), can cause the signal components from the speaker 110 in the first body signal and the second delayed signal to cancel each other out. This results in the first differential signal exhibiting a zero sound pickup characteristic in the direction of the speaker 110.

FIG. 10 shows a schematic diagram of the sound pickup direction pattern corresponding to the zero differential operation 41a in FIG. 9. As shown in FIG. 10, the sound sensor module 120 presents a zero sound pickup characteristic at the 180-degree direction. When the speaker 110 is located at the 180-degree direction or near the 180-degree direction, the sound sensor module 120 will not pick up (or will only pick up very little) the sound emitted by the speaker 110. Thus, the zero differential operation 41a shown in FIG. 9 is capable of adjusting the sound pickup direction pattern of the sound sensor module 120 to a heart-shaped pattern, with the zero sound pickup direction pointing toward the speaker 110. Therefore, the first differential signal obtained by the signal processing circuit 150 after performing the zero differential operation 41a on the first and second body signals, as shown in FIG. 7, does not contain (or contains very little) the signal components from the speaker 110.

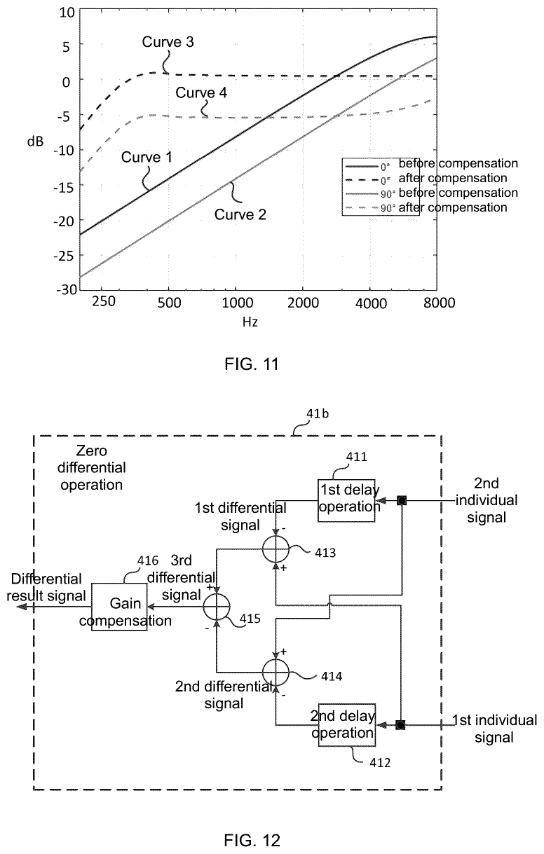

Furthermore, the inventors analyzed and experimented with the zero differential operation 41a in FIG. 9 and found that the zero differential operation 41a has an attenuation effect on components in certain frequency bands. An example is illustrated with reference to FIG. 11. FIG. 11 shows a schematic diagram of the frequency response curve of the first differential signal obtained using the zero differential operation 41a shown in FIG. 9. As shown in FIG. 11, curve 1 represents the frequency response curve of the first differential signal at the 0-degree direction, and curve 2 represents the frequency response curve of the first differential signal at the 90-degree direction. From curves 1 and 2, it can be seen that the components of the first differential signal in certain frequency bands (for example, below 1000 Hz) are attenuated. In other words, the sensitivity of the sound sensor module 120 to sound signals in these frequency bands is lower.

Therefore, in some exemplary embodiments, continuing to refer to FIG. 9, the zero differential operation 41a may further comprise a gain compensation operation 416. The gain compensation operation 416 is configured to perform gain compensation on the signal of at least part of the frequency band in the first differential signal to obtain a pickup result signal. For example, gain compensation can be performed on the components of the frequency band (e.g., below 1000 Hz) in the first differential signal that exhibit attenuation, so that the sound sensor module 120 also has high sensitivity to the sound signals in these frequency bands. Continuing to refer to FIG. 11, curve 3 shows the frequency response curve corresponding to the compensated first differential signal (i.e., the differential result signal) in the 0-degree direction, and curve 4 shows the frequency response curve corresponding to the compensated first differential signal (i.e., the differential result signal) in the 90-degree direction. It can be seen that the signal processing circuit 150, by performing the gain compensation operation 416 (i.e., performing gain compensation on the signal of at least part of the frequency band of the first differential signal), enables the sound sensor module 120 to have high and relatively flat sensitivity to sound signals across the entire frequency band.

As mentioned earlier, the zero differential operation 41a shown in FIG. 9 is suitable for scenarios where the speaker 110 is a far-field sound source. During the inventor's research, it was found that when the distance between the speaker 110 and the sound sensor module 120 is relatively close (e.g., less than or equal to 0.1 m), the aforementioned far-field assumption (i.e., the amplitude and direction of the sound signals collected by the two sound sensors are the same, with only a time difference between them) no longer holds. Therefore, for near-field sound source scenarios, if the zero differential operation 41a shown in FIG. 9 is used to adjust the sound pickup direction, the adjusted sound pickup direction pattern no longer exhibits a pickup zero. To address this, the present application also provides another zero differential operation that can be simultaneously applicable to both scenarios: where the speaker 110 is a far-field sound source and where the speaker 110 is a near-field sound source. This is explained below with reference to FIG. 12.

FIG. 12 shows a schematic diagram of another zero differential operation 41b provided according to some exemplary embodiments of the present application. As shown in FIG. 12, the zero differential operation 41b may comprise: a first delay operation 411, a second delay operation 412, a first differential operation 413, a second differential operation 414, and a third differential operation 415.

Among them, the first delay operation 411 is configured to delay the second individual signal to obtain a second delayed signal. In some exemplary embodiments, the delay duration for the second individual signal can be determined based on the aforementioned formula (4), which will not be elaborated herein. The second delay operation 412 is configured to delay the first individual signal to obtain a first delayed signal. In some exemplary embodiments, the delay duration for the first individual signal can be determined based on the aforementioned formula (4), which will not be elaborated herein. The first differential operation 413 is configured to perform a differential operation on the first individual signal and the second delayed signal (i.e., subtract the second delayed signal from the first individual signal) to obtain a first differential signal. The second differential operation 414 is configured to perform a differential operation on the second individual signal and the first delayed signal (i.e., subtract the first delayed signal from the second individual signal) to obtain a second differential signal. The third differential operation 415 is configured to perform a differential operation on the first differential signal and the second differential signal (i.e., subtract the second differential signal from the first differential signal) to obtain a third differential signal.

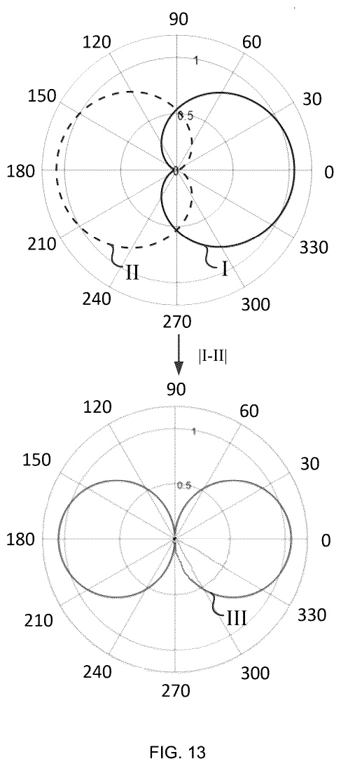

It should be understood that the principle of adjusting the sound pickup direction in the zero differential operation 41b shown in FIG. 12 is similar to that in FIG. 9, with the difference being that the zero differential operation 41b in FIG. 12 requires two delay operations. Therefore, the scheme shown in FIG. 9 can be referred to as a single-delay zero differential scheme, while the scheme shown in FIG. 12 can be referred to as a dual-delay zero differential scheme. FIG. 13 illustrates a schematic diagram of the sound pickup direction adjustment principle corresponding to the zero differential operation 41b in FIG. 12. As shown in FIG. 13, the signal processing circuit 150 can construct a cardioid pattern with the zero sound pickup direction pointing at 180 degrees (see pattern I in FIG. 13) by performing the first delay operation 411 and the first differential operation 413. This construction principle is the same as that in FIG. 9 and will not be elaborated herein. Furthermore, the signal processing circuit 150 can construct a cardioid pattern with the zero sound pickup direction pointing at 0 degrees (see pattern II in FIG. 13) by performing the second delay operation 412 and the second differential operation 414. This construction principle is also similar to that in FIG. 9 and will not be detailed herein. It should be understood that the cardioid pattern with the zero sound pickup direction pointing at 180 degrees in FIG. 13 (i.e., pattern I) corresponds to the first differential signal, and the cardioid pattern with the zero sound pickup direction pointing at 0 degrees (i.e., pattern II) corresponds to the second differential signal. The signal processing circuit 150 can obtain a pattern of number 8 with the zero sound pickup direction pointing at 90 degrees and 270 degrees (see pattern III in FIG. 13) by performing the third differential operation 415 (equivalent to subtracting pattern II from pattern I).

From the aforementioned number 8 shaped sound pickup direction pattern (i.e., pattern III), it can be seen that the sound sensor module 120 exhibits pickup zero characteristics in the 90-degree and 270-degree directions. When the speaker 110 is located at 90 degrees/270 degrees or near these directions, the sound sensor module 120 will not pick up (or will pick up very little of) the sound emitted by the speaker 110. Thus, it is evident that the dual-delay-based zero differential operation 41b shown in FIG. 12 can adjust the sound pickup direction pattern of the sound sensor module 120 to a pattern of number 8, with the zero sound pickup direction pointing toward the speaker 110. Therefore, the third differential signal obtained by the signal processing circuit 150 through executing the zero differential operation 41b does not contain (or contains very little of) the signal components from the speaker 110.

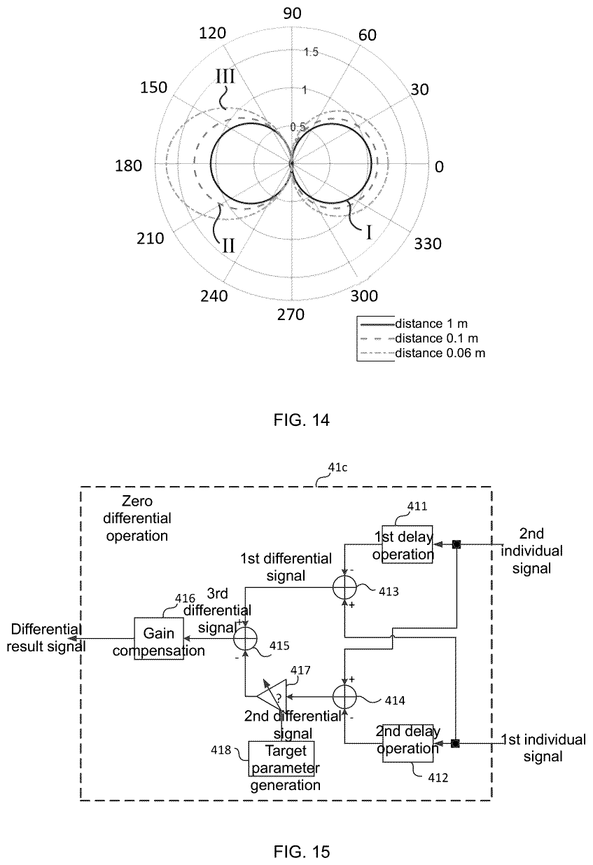

FIG. 14 illustrates a schematic diagram of the sound pickup direction patterns of the zero differential operation 41b in FIG. 12 under three different scenarios. As shown in FIG. 14, pattern I exemplifies the sound pickup direction pattern obtained when the distance between the speaker 110 and the sound sensor module 120 is 1 m, pattern II exemplifies the sound pickup direction pattern obtained when the distance between the speaker 110 and the sound sensor module 120 is 0.1 m, and pattern III exemplifies the sound pickup direction pattern obtained when the distance between the speaker 110 and the sound sensor module 120 is 0.06 m. As can be seen from FIG. 14, regardless of the distance between the speaker 110 and the sound sensor module 120, the zero differential operation 41b shown in FIG. 12 can consistently produce a sound pickup direction pattern of number 8. Therefore, the zero differential operation 41b shown in FIG. 12 can be applied to scenarios where the speaker 110 is a near-field sound source as well as scenarios where the speaker 110 is a far-field sound source. Consequently, the zero differential operation 41b shown in FIG. 12 can effectively reduce the signal components from the speaker 110 in the third differential signal across all scenarios.

Furthermore, continuing to refer to FIG. 12, the zero differential operation 41b may also comprise a gain compensation operation 416. The gain compensation operation 416 is configured to perform gain compensation on the signal of at least part of the frequency band in the third differential signal to obtain a pickup result signal. It should be understood that the principle and function of the gain compensation operation 416 in FIG. 12 are the same as those of the gain compensation operation 416 in FIG. 9, and will not be elaborated herein.

When using the zero differential operation 41b shown in FIG. 12, the pickup zero direction of the sound sensor module 120 points to 90 degrees and 270 degrees, meaning that all positions along the perpendicular bisector of the first sound sensor 120-1 and the second sound sensor 120-2 are located in the pickup zero direction of the sound sensor module 120. Therefore, during product design, the speaker 110 can be positioned on the perpendicular bisector of the first sound sensor 120-1 and the second sound sensor 120-2, ensuring that the pickup result signal of the sound sensor module 120 does not contain signal components from the speaker 110. However, in practical applications, due to factors such as product form, manufacturing tolerances, and wearing posture, the speaker 110 typically cannot be precisely located on the perpendicular bisector of the first sound sensor 120-1 and the second sound sensor 120-2. As a result, the signal components from the speaker 110 in the pickup result signal of the sound sensor module 120 are reduced compared to a pickup result signal that has not undergone the zero differential operation, but some signal components from the speaker 110 still remain. To address this, the present application also provides another zero differential operation that can adaptively adjust the zero sound pickup direction to minimize the signal components from the speaker 110 in the pickup result signal. This is explained below with reference to FIG. 15.

FIG. 15 shows a schematic diagram of yet another zero differential operation 41c provided according to some exemplary embodiments of the present application. As shown in FIG. 15, based on the zero differential operation 41b shown in FIG. 12, this zero differential operation 41c may further comprise a multiplication operation 417 and a target parameter generation operation 418. The target parameter generation operation 418 is configured to generate a target parameter β with the goal of minimizing the signal components from the speaker 110 in the third differential signal. The multiplication operation 417 is performed either between the second differential operation 414 and the third differential operation 415 or between the first differential operation 413 and the third differential operation 415. For ease of description, the following text and figures in this disclosure take the example of “the multiplication operation 417 being performed between the second differential operation 414 and the third differential operation 415” for illustration. Specifically, the multiplication operation 417 is configured to multiply the target parameter β by the second differential signal to obtain a multiplication result, so that the third differential operation 415 performs a differential operation on the first differential signal and the multiplication result to obtain the third differential signal.

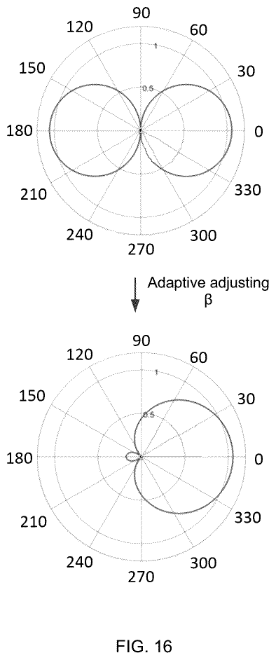

It should be understood that the second differential signal corresponds to pattern II in FIG. 13 (i.e., a cardioid pattern with the zero sound pickup direction pointing at 0 degrees). The signal processing circuit 150 adjusts the second differential signal by multiplying it with the target parameter β. Subsequently, by performing the third differential operation 415 based on the first differential signal and the adjusted second differential signal, the zero sound pickup direction can be adjusted from 90 degrees/270 degrees to other angles. FIG. 16 illustrates a schematic diagram of the adjustment of the zero sound pickup direction by the target parameter β according to some exemplary embodiments of the present application. As shown in FIG. 16, when the target parameter β is set to 0.99, the zero points in the sound pickup direction pattern point to 90 degrees and 270 degrees; when the target parameter β is updated to 0.16, the zero points in the sound pickup direction pattern shift to 135 degrees and 225 degrees. Thus, it can be seen that the signal processing circuit 150, by performing the multiplication operation 417 and the target parameter generation operation 418, can adaptively adjust the zero sound pickup direction to minimize the signal components from the speaker 110 in the pickup result signal.

It should be noted that the various zero differential operations 41 involved in this disclosure (e.g., the zero differential operation 41a shown in FIG. 9, the zero differential operation 41b shown in FIG. 12, and the zero differential operation 41c shown in FIG. 15) can be performed either in the time domain or in the frequency domain, and this disclosure does not impose any limitations in this regard.

In some exemplary embodiments, any one or more of the aforementioned first delay operation 411, second delay operation 412, first differential operation 413, second differential operation 414, third differential operation 415, gain compensation operation 416, multiplication operation 417, and target parameter generation operation 418 may be implemented by the processor 220 in the signal processing circuit 150. That is, the processor 220 executes an instruction set and performs one or more of the above operations according to the instructions in the set. In some exemplary embodiments, the signal processing circuit 150 may comprise a first delay circuit, and the aforementioned first delay operation 411 may be implemented by the first delay circuit. In some exemplary embodiments, the signal processing circuit 150 may comprise a second delay circuit, and the aforementioned second delay operation 412 may be implemented by the second delay circuit. In some exemplary embodiments, the signal processing circuit 150 may comprise a first differential circuit, and the aforementioned first differential operation 413 may be implemented by the first differential circuit. In some exemplary embodiments, the signal processing circuit 150 may comprise a second differential circuit, and the aforementioned second differential operation 414 may be implemented by the second differential circuit. In some exemplary embodiments, the signal processing circuit 150 may comprise a third differential circuit, and the aforementioned third differential operation 415 may be implemented by the third differential circuit. In some exemplary embodiments, the signal processing circuit 150 may comprise a gain compensation circuit, and the aforementioned gain compensation operation 416 may be implemented by the gain compensation circuit. In some exemplary embodiments, the signal processing circuit 150 may comprise a multiplication circuit, and the aforementioned multiplication operation 417 may be implemented by the multiplication circuit. In some exemplary embodiments, the signal processing circuit 150 may comprise a target parameter generation circuit, and the aforementioned target parameter generation operation 418 may be implemented by the target parameter generation circuit.

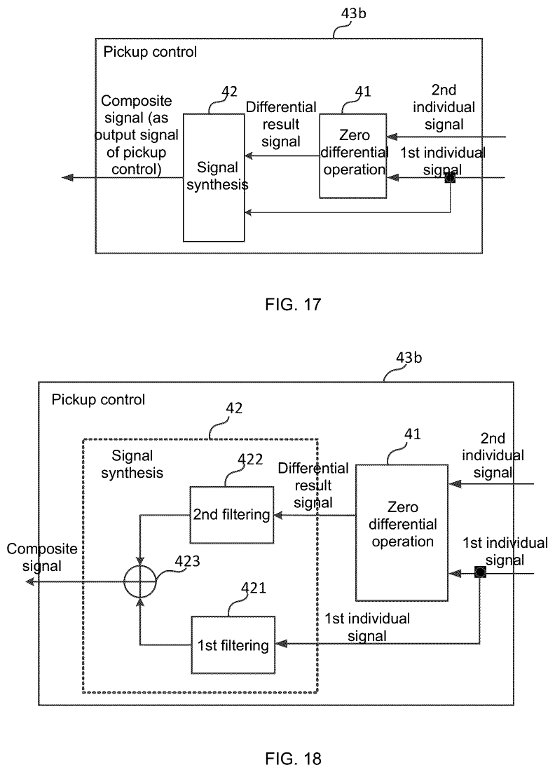

The zero differential operation 41 described earlier performs zero differential across the entire frequency band of the first individual signal and the second individual signal (i.e., the sound pickup frequency band of the sound sensor module 120). Therefore, the zero differential operation 41 can direct the zero sound pickup direction of the sound sensor module 120 toward the speaker across the entire frequency band. From this, it can be seen that the sound pickup control operation 43a shown in FIG. 8 can reduce the pickup of the target sound across the entire frequency band. In some exemplary embodiments, the signal processing circuit 150 can also reduce the pickup of the target sound in a specific frequency band, in which case the sound pickup control operation 43b shown in FIG. 17 can be employed. This is explained below with reference to FIG. 17. For ease of description, it is assumed in the following text that the sound pickup frequency band of the sound sensor module 120 comprises a first frequency band and a second frequency band, where the target frequency band corresponds to the first frequency band. In other words, the signal processing circuit 150 reduces the pickup of the target sound in the first frequency band.

FIG. 17 illustrates a schematic diagram of another sound pickup control operation 43b provided according to some exemplary embodiments of the present application. As shown in FIG. 17, the sound pickup control operation 43b may comprise a zero differential operation 41 and a signal synthesis operation 42. The zero differential operation 41 is configured to perform zero differential on the first individual signal and the second individual signal to adjust the zero sound pickup direction of the sound sensor module 120 to point toward the speaker 110, thereby obtaining a differential result signal. It should be understood that the zero differential operation 41 in FIG. 17 can adopt the zero differential operation 41a shown in FIG. 9, the zero differential operation 41b shown in FIG. 12, or the zero differential operation 41c shown in FIG. 15. For specifics, refer to the descriptions in the relevant sections above, which will not be repeated herein.

The signal synthesis operation 42 is configured to synthesize the differential result signal and the first individual signal to obtain a composite signal, where the components of the first frequency band in the composite signal come from the differential result signal, and the components of the second frequency band come from either the first individual signal or the second individual signal. Since the first individual signal and the second individual signal have not undergone the zero differential operation 41, compared to the differential result signal, they can more accurately reflect certain characteristics of the real ambient sound (e.g., background noise characteristics). Therefore, when the signal in the second frequency band comes from the first individual signal or the second individual signal, the composite signal retains components of the original signal, allowing the composite signal to more accurately reflect the characteristics of the real ambient sound. It can be understood that, in the case where the signal in the first frequency band of the composite signal comes from the differential result signal and the signal in the second frequency band comes from the first individual signal or the second individual signal, the composite signal both preserves components of the original signal and reduces signal components from the speaker 110. As a result, the composite signal can reduce the signal components from the speaker 110 while striving to accurately reflect the real ambient sound, thereby improving the accuracy of the composite signal. For ease of description, the following descriptions will take the example where the signal in the second frequency band comes from the first individual signal. It should be understood that when the signal in the second frequency band comes from the second individual signal, the implementation is similar, and this disclosure will not elaborate further on this.

From the previous description, it is clear that the zero differential operation 41 (e.g., the zero differential operation 41a shown in FIG. 9, the zero differential operation 41b shown in FIG. 12, and the zero differential operation 41c shown in FIG. 15) all comprise a gain compensation operation 416. This gain compensation operation 416 inevitably causes the background noise components in certain frequency bands of the pickup result signal to be amplified. When the background noise is amplified to a certain sound intensity, it can affect the user's auditory experience. Therefore, in some exemplary embodiments, the second frequency band may comprise the frequency band corresponding to the background noise of the current environment, while the first frequency band comprises the frequency bands excluding the second frequency band. In this way, when the components of the second frequency band (i.e., the frequency band corresponding to the background noise) in the composite signal come from the first individual signal, and the components of the first frequency band (i.e., the frequency bands other than the one corresponding to the background noise) come from the differential result signal, since the first individual signal has not undergone the zero differential operation 41, it can accurately reflect the background noise characteristics of the current environment. As a result, the issue of amplified background noise components can be avoided.

In practical applications, considering that background noise in the environment is typically low-frequency noise, in some exemplary embodiments, the frequencies in the first frequency band may be higher than those in the second frequency band. For example, the first frequency band could be a high frequency band, while the second frequency band could be a low frequency band. Alternatively, the first frequency band could be a mid-high frequency band, and the second frequency band could be a low frequency band. Another example could be that the first frequency band is a high frequency band, and the second frequency band is a mid-low frequency band. Yet another example could be that the first frequency band is a mid-frequency band, and the second frequency band is a low frequency band, and so on. In other words, the lower frequency range within the sound pickup frequency band of the sound sensor module 120 is designated as the second frequency band, and the components of the second frequency band in the composite signal are taken from the first signal, thereby avoiding the issue of amplified background noise components.

Herein, the aforementioned low frequency band generally refers to a frequency band below approximately 1 KHz, the mid frequency band refers to a frequency band roughly between 1 KHz and 4 KHz, the high frequency band refers to a frequency band above 4 KHz, the mid-low frequency band refers to a frequency band roughly below 4 KHz, and the mid-high frequency band refers to a frequency band roughly above 1 KHz. A person of ordinary skill in the art should understand that the distinction of these frequency bands is provided as an example with approximate ranges. The definitions of these frequency bands may vary depending on different industries, application scenarios, and classification standards. For instance, in some application scenarios, the low frequency band may refer to a frequency band roughly from 20 Hz to 150 Hz, the mid frequency band may refer to a frequency band roughly from 150 Hz to 5 KHz, the high frequency band may refer to a frequency band roughly from 5 KHz to 20 KHz, the mid-low frequency band may refer to a frequency band roughly from 150 Hz to 500 Hz, and the mid-high frequency band may refer to a frequency band roughly from 500 Hz to 5 KHz. In other application scenarios, the low frequency band may refer to a frequency band roughly from 20 Hz to 80 Hz, the mid-low frequency band may refer to a frequency band roughly between 80 Hz and 160 Hz, the mid frequency band may refer to a frequency band roughly from 160 Hz to 1280 Hz, the mid-high frequency band may refer to a frequency band roughly from 1280 Hz to 2560 Hz, and the high frequency band may refer to a frequency band roughly from 2560 Hz to 20 KHz.

In some exemplary embodiments, the aforementioned zero differential operation 41 and/or signal synthesis operation 42 may be implemented by the processor 220 in the signal processing circuit 150. That is, the processor 220 executes an instruction set and performs the zero differential operation 41 and/or the signal synthesis operation 42 according to the instructions in the set. In some exemplary embodiments, the signal processing circuit 150 may comprise a zero differential circuit, and the aforementioned zero differential operation 41 may be implemented by the zero differential circuit. In some exemplary embodiments, the signal processing circuit 150 may comprise a signal synthesis circuit, and the aforementioned signal synthesis operation 42 may be implemented by the signal synthesis circuit.

FIG. 18 illustrates a schematic diagram of yet another sound pickup control operation 43b provided according to some exemplary embodiments of the present application, which refines the explanation of the signal synthesis operation 42 in FIG. 17. As shown in FIG. 18, the signal synthesis operation 42 may comprise a first filtering operation 421, a second filtering operation 422, and a synthesis operation 424. The first filtering operation 421 is configured to perform a first filtering on the first individual signal to obtain the components of the second frequency band in the first individual signal. For example, when the second frequency band is a low frequency band, the first filtering operation 421 can be implemented using a low-pass filter. The second filtering operation 422 is configured to perform a second filtering on the differential result signal to obtain the components of the first frequency band in the differential result signal. For example, when the first frequency band is a high frequency band, the second filtering operation 422 can be implemented using a high-pass filter. The synthesis operation 424 is configured to synthesize the components of the second frequency band obtained from the first filtering operation 421 with the components of the first frequency band obtained from the second filtering operation 422 to produce the composite signal. In some exemplary embodiments, the synthesis operation 424 can be implemented using an adder. Thus, it can be seen that the signal processing circuit 150, by performing the signal synthesis operation 42, ensures that the first frequency band in the composite signal comes from the differential result signal, while the second frequency band comes from the first individual signal.

In some exemplary embodiments, the aforementioned first filtering and second filtering may be complementary filters, meaning that the sum of the transfer function of the first filtering and the transfer function of the second filtering equals 1. For example, assuming the transfer function corresponding to the first filtering is expressed as the following formula (5), the transfer function corresponding to the second filtering can be expressed as the following formula (6).

$$Filter\_ 1 = \frac{B ( z )}{A ( z )} \qquad Formula ( 5 )$$

$$Filter\_ 2 = \frac{A ( z ) - B ( z )}{A ( z )} \qquad Formula ( 6 )$$

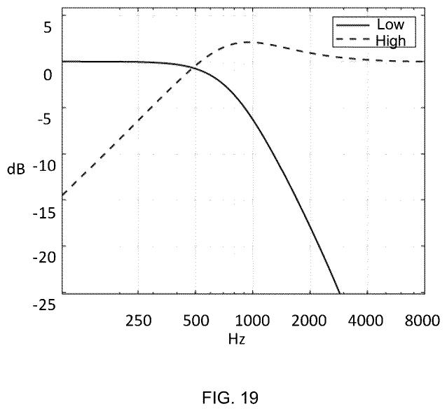

From formulas (5) and (6), it can be seen that the denominator expressions corresponding to the transfer functions of the two filtering operations are identical, both being A(z), while the numerator expressions corresponding to the transfer functions of the two filtering operations are B(z) and A(z)−B(z), respectively. This design ensures that the sum of the transfer functions of the two filtering operations equals 1, thereby exhibiting all-pass characteristics when the two filtering operations are used in combination. For ease of understanding, FIG. 19 illustrates a schematic diagram of the frequency response curves corresponding to a set of complementary filtering operations provided according to some exemplary embodiments of the present application. As shown in FIG. 19, curve 1 may correspond to the frequency response curve of the first filtering operation 421 in FIG. 18, exhibiting low-pass characteristics, while curve 2 may correspond to the frequency response curve of the second filtering operation 422 in FIG. 18, exhibiting high-pass characteristics. When these two filtering operations are used in combination, they will exhibit all-pass characteristics.

It should be noted that the complementary filtering operations exemplified by the aforementioned formulas (5) and (6) are merely one possible example. A person skilled in the art can understand that any filter bank capable of achieving frequency division and synthesis is feasible. For instance, in some exemplary embodiments, the aforementioned first filtering and second filtering can also be implemented using a first filter and a second filter with the same cutoff frequency. Here, the cutoff frequency of the first filter is w1, and the cutoff frequency of the second filter is w2, with the two filters having identical cutoff frequencies: w1=w2. Additionally, the amplitude responses of the two filters at the cutoff frequency satisfy

$$\vert Fil {r}_{1 ( {W}_{1} )} \vert = \vert {Filter}_{2 ( {w}_{2} )} \vert = - 3 dB .$$

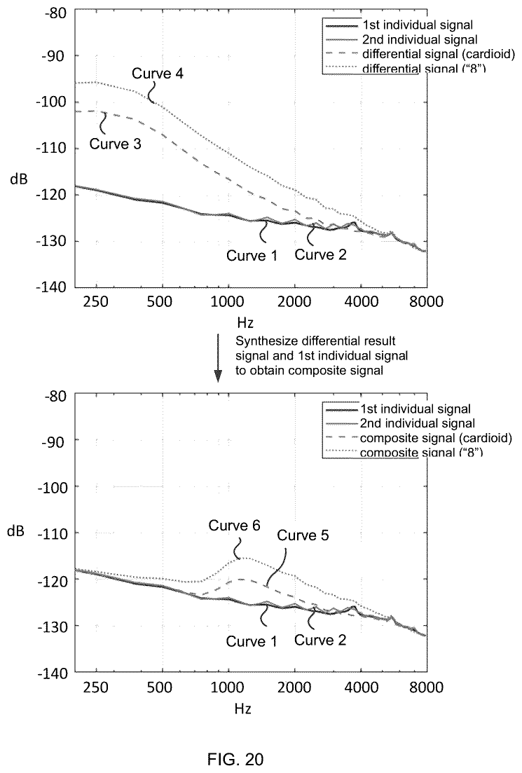

FIG. 20 shows a schematic diagram of the background noise components corresponding to the differential result signal and the composite signal in FIG. 18. As shown in FIG. 20, curve 1 represents the background noise component in the first individual signal, and curve 2 represents the background noise component in the second individual signal. Curve 3 shows the background noise component in the differential result signal obtained using the zero differential operation 41a shown in FIG. 9 (corresponding to a cardioid sound pickup direction pattern). Curve 4 shows the background noise component in the differential result signal obtained using the zero differential scheme 41b shown in FIG. 12 (corresponding to a sound pickup direction pattern of number 8). From curves 3 and 4, it can be seen that both the zero differential operation 41a shown in FIG. 9 (single-delay zero differential scheme) and the zero differential operation 41b shown in FIG. 12 (dual-delay zero differential scheme) result in a significant amplification of the background noise in the low frequency band (i.e., the second frequency band), thereby causing substantial noise interference to the user.

Continuing to refer to FIG. 20, curve 5 illustrates the background noise component in the composite signal obtained by performing frequency band synthesis on the first individual signal and the differential result signal derived from the zero differential operation 41a shown in FIG. 9 (corresponding to a cardioid sound pickup direction pattern). Curve 6 illustrates the background noise component in the composite signal obtained by performing frequency band synthesis on the first individual signal and the differential result signal derived from the zero differential operation 41b shown in FIG. 12 (corresponding to a sound pickup direction pattern of number 8). As can be seen from curves 5 and 6, the signal processing circuit 150, by executing the signal synthesis operation 42, can mitigate the background noise amplification issue caused by the zero differential operation 41, thereby preventing noise interference for the user.

In some exemplary embodiments, when there are multiple speakers 110, the sound emission frequency bands corresponding to different speakers may vary. In such cases, different zero differential schemes can be applied to different frequency bands, ensuring that the zero sound pickup direction of the sound sensor module 120 in each frequency band points to the speaker corresponding to that frequency band, thereby minimizing the signal components from each speaker in the composite signal as much as possible. Taking two speakers as an example, for ease of description, the two speakers are referred to as the first speaker and the second speaker, respectively. The first frequency band may comprise a first sub-frequency band and a second sub-frequency band. Accordingly, the signal in the first sub-frequency band of the composite signal comes from the first pickup result signal obtained by the sound sensor module 120 in a first pickup state, where the first pickup state corresponds to the zero sound pickup direction of the sound sensor module 120 pointing to the first speaker. The signal in the second sub-frequency band of the composite signal comes from the second pickup result signal obtained by the sound sensor module 120 in a second pickup state, where the second pickup state corresponds to the zero sound pickup direction of the sound sensor module 120 pointing to the second speaker. The sound pickup direction patterns corresponding to the first pickup state and the second pickup state are different. In other words, when the signal processing circuit 150 executes the sound pickup control operation 43, it can apply different zero differential operations 41 to the first sub-frequency band and the second sub-frequency band, resulting in different sound pickup direction patterns for the first sub-frequency band and the second sub-frequency band. In practical applications, considering that each zero differential scheme may have varying zero attenuation effects (i.e., the sound intensity attenuation in the zero sound pickup direction) across different frequency bands, the zero differential operation 41 with better zero attenuation performance can be selected for the first sub-frequency band and the second sub-frequency band based on the zero attenuation performance of each zero differential operation 41 in different frequency bands, thereby enhancing the overall zero attenuation effect across the entire frequency band.

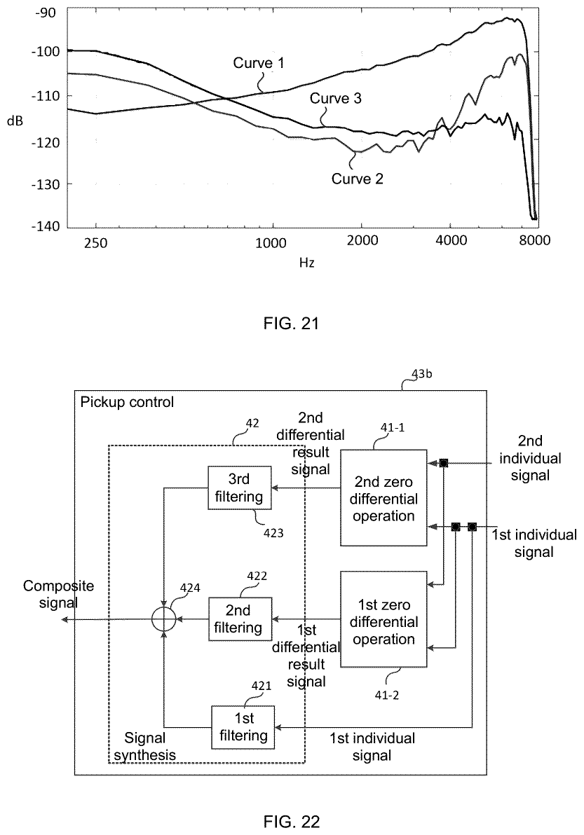

FIG. 21 illustrates a schematic diagram of the zero attenuation effects corresponding to different zero differential operations according to some exemplary embodiments of the present application. As shown in FIG. 21, curve 1 represents the frequency response diagram of the first individual signal. Curve 2 represents the frequency response diagram in the zero sound pickup direction of the differential result signal obtained using the zero differential operation 41a shown in FIG. 9 (corresponding to a cardioid sound pickup direction pattern). Curve 3 represents the frequency response diagram in the zero sound pickup direction of the differential result signal obtained using the zero differential operation 41b shown in FIG. 12 (corresponding to a sound pickup direction pattern of number 8). As can be seen from FIG. 21, within the 1 kHz-4 KHz frequency band, the attenuation of curve 2 relative to curve 1 is greater than the attenuation of curve 3 relative to curve 1. This indicates that the sound intensity attenuation in the zero sound pickup direction of the zero differential operation 41a shown in FIG. 9 (corresponding to a cardioid sound pickup direction pattern) is greater than that of the zero differential operation 41b shown in FIG. 12 (corresponding to a sound pickup direction pattern of number 8). Therefore, within the 1 kHz-4 KHz frequency band, the null attenuation effect of the zero differential operation 41a shown in FIG. 9 (corresponding to a cardioid sound pickup direction pattern) is superior to that of the zero differential operation 41b shown in FIG. 12 (corresponding to a sound pickup direction pattern of number 8).

Continuing to refer to FIG. 21, within the 4 kHz-8 KHz frequency band, the attenuation of curve 3 relative to curve 1 is more pronounced than the attenuation of curve 2 relative to curve 1. This indicates that the sound intensity attenuation in the zero sound pickup direction of the zero differential operation 41b shown in FIG. 12 (corresponding to the sound pickup direction pattern of number 8) is greater than that of the zero differential operation 41a shown in FIG. 9 (corresponding to a cardioid sound pickup direction pattern). Therefore, within the 4 kHz-8 kHz frequency band, the zero attenuation effect of the zero differential operation 41b shown in FIG. 12 (corresponding to the sound pickup direction pattern of number 8) is superior to that of the zero differential operation 41a shown in FIG. 9 (corresponding to a cardioid sound pickup direction pattern).

Based on the comparison of zero attenuation effects shown in FIG. 21, in some exemplary embodiments, the first frequency band can be divided into a first sub-frequency band and a second sub-frequency band, with the frequencies in the first sub-frequency band being lower than those in the second sub-frequency band. For example, the first sub-frequency band could be a mid-frequency band (such as 1 KHz-4 kHz as shown in FIG. 21), and the second sub-frequency band could be a high frequency band (such as 4 kHz-8 KHz as shown in FIG. 21). In this case, for the first sub-frequency band, the zero differential operation 41a shown in FIG. 9 can be employed, resulting in a cardioid sound pickup direction pattern for the sound sensor module 120. For the second sub-frequency band, the zero differential operation 41b shown in FIG. 12 or the zero differential operation 41c shown in FIG. 15 can be employed, resulting in a sound pickup direction pattern of number 8 for the sound sensor module 120. Consequently, both the first sub-frequency band and the second sub-frequency band exhibit significant attenuation in the zero sound pickup direction, thereby enhancing the overall zero attenuation effect.

FIG. 22 illustrates a schematic diagram of yet another sound pickup control operation 43b provided according to some exemplary embodiments of the present application. It assumes that the acoustic system 003 comprises a first speaker and a second speaker, where the sound emission frequency band of the first speaker comprises a first sub-frequency band, and the sound emission frequency band of the second speaker comprises a second sub-frequency band. FIG. 22 is applicable to scenarios where different zero differential operations are employed for the first sub-frequency band and the second sub-frequency band, respectively. As shown in FIG. 22, the zero differential operation 41 may comprise a first zero differential operation 41-1 and a second zero differential operation 41-2. The first zero differential operation 41-1 may adopt the zero differential operation 41a shown in FIG. 9 (i.e., a single-delay zero differential scheme, corresponding to a cardioid sound pickup direction pattern), while the second zero differential operation 41-2 may adopt the zero differential operation 41b shown in FIG. 12 or the zero differential operation 41c shown in FIG. 15 (i.e., a dual-delay zero differential scheme, corresponding to a sound pickup direction pattern of number 8). After obtaining the first individual signal and the second individual signal, the signal processing circuit 150 can perform the first zero differential operation 41-1 on the first individual signal and the second individual signal to adjust the zero sound pickup direction of the sound sensor module 120 to point toward the first speaker, thereby obtaining a first differential result signal. Similarly, it can perform the second zero differential operation 41-2 on the first individual signal and the second individual signal to adjust the zero sound pickup direction of the sound sensor module 120 to point toward the second speaker, thereby obtaining a second differential result signal.

Continuing to refer to FIG. 22, the signal synthesis operation 42 may comprise a first filtering operation 421, a second filtering operation 422, a third filtering operation 423, and a synthesis operation 424. The first filtering operation 421 is configured to perform a first filtering on the first individual signal to obtain the components of the second frequency band in the first individual signal. For example, the second frequency band may be a low frequency band (e.g., less than 1000 Hz), and in this case, the first filtering operation 421 can be implemented using a low-pass filter. The second filtering operation 422 is configured to perform a second filtering on the first differential result signal to obtain the components of the first sub-frequency band in the first differential result signal. For example, the first sub-frequency band may be a high frequency band (e.g., greater than 4 kHz), and in this case, the second filtering operation 422 can be implemented using a high-pass filter. The third filtering operation 423 is configured to perform a third filtering on the second differential result signal to obtain the components of the second sub-frequency band in the second differential result signal. For example, the second sub-frequency band may be a mid-frequency band (e.g., 1 kHz-4 kHz), and the second filtering operation 422 can be implemented using a bandpass filter. The synthesis operation 424 is configured to synthesize the components of the second frequency band obtained from the first filtering operation 421, the components of the first sub-frequency band obtained from the second filtering operation 422, and the components of the second sub-frequency band obtained from the third filtering operation 423 to produce the composite signal. In some exemplary embodiments, the synthesis operation 424 can be implemented using an adder.

Similar to what is shown in FIG. 18, the first filtering operation 421, second filtering operation 422, and third filtering operation 423 in FIG. 22 can be referred to as a set of complementary filters, in other words, the sum of the transfer function corresponding to the first filtering operation 421, the transfer function corresponding to the second filtering operation 422, and the transfer function corresponding to the third filtering operation 423 equals 1. For explanations and effects regarding complementary filters, refer to the relevant descriptions earlier, which will not be repeated herein.

In some exemplary embodiments, any one or more of the aforementioned first filtering operation 421, second filtering operation 422, third filtering operation 423, and synthesis operation 424 may be implemented by the processor 220 in the signal processing circuit 150. That is, the processor 220 executes an instruction set and performs one or more of the above operations according to the instructions in the set. In some exemplary embodiments, the signal processing circuit 150 may comprise a first filtering circuit, and the aforementioned first filtering operation 421 may be implemented by the first filtering circuit. In some exemplary embodiments, the signal processing circuit 150 may comprise a second filtering circuit, and the aforementioned second filtering operation 422 may be implemented by the second filtering circuit. In some exemplary embodiments, the signal processing circuit 150 may comprise a third filtering circuit, and the aforementioned third filtering operation 423 may be implemented by the third filtering circuit. In some exemplary embodiments, the signal processing circuit 150 may comprise a synthesis circuit, and the aforementioned synthesis operation 424 may be implemented by the synthesis circuit.

S340: Perform a second target operation on the target signal.

After obtaining the target signal, the signal processing circuit 150 can perform a second target operation 50 on the target signal based on the requirements of the application scenario. In some exemplary embodiments, continuing to refer to FIG. 6 and FIG. 7, the signal processing circuit 150 may also be connected to the speaker 110. In this case, the second target operation 50 may comprise a gain amplification operation 51. After obtaining the target signal, the signal processing circuit 150 can perform the gain amplification operation 51 to amplify the gain of the target signal and then send the gain-amplified signal to the speaker 110 to enable the speaker 110 to emit sound. In some exemplary embodiments, when the acoustic system 003 comprises a first speaker and a second speaker, the signal processing circuit 150 can perform the gain amplification operation 51 on the target signal to obtain a gain-amplified signal. Subsequently, based on the sound emission frequency bands of the first speaker and the second speaker, the signal processing circuit 150 can perform a frequency division operation on the gain-amplified signal and send the divided signals to the first speaker and the second speaker, respectively. For example, assuming the sound emission frequency band of the first speaker comprises a second frequency band and a first sub-frequency band, and the sound emission frequency band of the second speaker comprises a second sub-frequency band, the frequency division operation can extract a first target signal corresponding to the second frequency band and the first sub-frequency band, and a second target signal corresponding to the second sub-frequency band from the gain-amplified signal. Subsequently, the signal processing circuit 150 can send the first target signal to the first speaker and the second target signal to the second speaker. The frequency division operation can be implemented using filters or other feasible methods, and this disclosure does not impose any limitations on this. The above scheme can be applied to the howling suppression scenario shown in FIG. 1. It should be understood that since the target signal has reduced signal components from the speaker 110 (or the signal strength from the speaker 110 has been lowered), the conditions for the sound emitted by the speaker 110 to generate howling in the closed-loop circuit shown in FIG. 1 are disrupted, thereby achieving the effect of suppressing howling. In some exemplary embodiments, the aforementioned gain amplification operation 51 can be implemented by the processor 220 in the signal processing circuit 150, where the processor 220 executes an instruction set and performs the gain amplification operation 51 according to the instructions in the set. In some exemplary embodiments, the signal processing circuit 150 may comprise a gain amplification circuit, and the aforementioned gain amplification operation 51 can be implemented by the gain amplification circuit.

In some exemplary embodiments, the speaker 110, sound sensor module 120, and signal processing circuit 150 are integrated in a first acoustic device, which is communicatively connected to a second acoustic device. In this scenario, the second target operation 50 may comprise: sending the target signal to the second acoustic device to reduce the echo of the second acoustic device. The above solution can be applied to the echo cancellation scenario shown in FIG. 2. For example, the first acoustic device can be a local device, and the second acoustic device can be a remote device. Since the target signal reduces the signal components from the speaker (or reduces the signal strength from the speaker), it is equivalent to reducing the sound from the second acoustic device. Therefore, when the second acoustic device receives and plays the target signal, the user on the second acoustic device side (i.e., the remote user) will not hear or hear less echo, thereby achieving the effect of echo cancellation.

In summary, this disclosure provides a signal processing method and an acoustic system, where the signal processing method comprises: obtaining a first signal and a second signal, the first signal being obtained by the first sound sensor in the sound sensor module when collecting ambient sound, the second signal being obtained by the second sound sensor in the sound sensor module when collecting ambient sound, the ambient sound including at least the target sound emitted when the speaker is working, performing a first target operation on the first signal and the second signal to reduce the pickup of the target sound by the sound sensor module in the target frequency band and attenuate the signal corresponding to the target sound picked up by the sound sensor module, thereby obtaining a target signal, and then performing a second target operation on the target signal. In the above solution, since the first target operation can reduce the pickup of the target sound by the sound sensor module on the one hand, and can also attenuate the signal corresponding to the target sound picked up by the sound sensor module on the other hand, the obtained target signal does not contain or contains less signal components from the speaker, so that the acoustic system can achieve the effect of suppressing howling or eliminating echo.

Another aspect of this disclosure provides a non-transitory storage medium storing at least one set of executable instructions for performing image recognition. When the executable instructions are executed by a processor, the executable instructions direct the processor to implement the steps of the image recognition method P100 described in this disclosure. In some possible embodiments, various aspects of this disclosure may also be implemented in the form of a program product, which comprises program code. When the program product runs on a computing device 600, the program code is used to cause the computing device 600 to perform the steps of the image recognition method P100 described in this disclosure. The program product for implementing the above method may adopt a portable compact disc read-only memory (CD-ROM) that comprises program code and can run on the computing device 600. However, the program product of this disclosure is not limited to this. In this disclosure, the readable storage medium may be any tangible medium that contains or stores a program, which can be used by or in combination with an instruction execution system. The program product may adopt any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or any combination thereof. More specific examples of readable storage media comprise: an electrical connection with one or more wires, a portable disk, a hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the above. The computer-readable storage medium may comprise a data signal propagated in baseband or as part of a carrier wave, which carries readable program code. Such propagated data signals may take various forms, including but not limited to electromagnetic signals, optical signals, or any suitable combination of the above. The readable storage medium may also be any readable medium other than a readable storage medium that can send, propagate, or transmit a program for use by or in combination with an instruction execution system, apparatus, or device. The program code contained on the readable storage medium may be transmitted using any appropriate medium, including but not limited to wireless, wired, optical cable, RF, etc., or any suitable combination of the above. Program code for performing the operations of this disclosure may be written in any combination of one or more programming languages, including object-oriented programming languages-such as Java, C++, etc.—as well as conventional procedural programming languages-such as the “C” language or similar programming languages. The program code may be executed entirely on the computing device 600, partially on the computing device 600, as a standalone software package, partially on the computing device 600 and partially on a remote computing device, or entirely on a remote computing device.

The above description pertains to specific embodiments of the present specification. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

In summary, after reading this detailed disclosure, a person skilled in the art can understand that the aforementioned detailed disclosure is presented only by way of example and is not intended to be limiting. Although not explicitly stated here, a person skilled in the art will appreciate that the disclosure encompasses various reasonable alterations, improvements, and modifications to the embodiments. These alterations, improvements, and modifications are intended to be within the spirit and scope of the exemplary embodiments presented in this specification.

In addition, certain terms in this specification have been used to describe the embodiments of the specification. For example, the terms “one embodiment,” “embodiment,” and/or “some exemplary embodiments” mean that specific features, structures, or characteristics described in connection with that embodiment may be included in at least one embodiment of the specification. Therefore, it should be emphasized and understood that references to “embodiment,” “one embodiment,” or “alternative embodiment” in various parts of this specification do not necessarily refer to the same embodiment. Additionally, specific features, structures, or characteristics may be appropriately combined in one or more embodiments of the specification.

It should be understood that in the foregoing description of the embodiments of the specification, in order to aid in understanding a feature and simplify the presentation, various features are combined in a single embodiment, drawing, or description. However, this does not mean that the combination of these features is required. A person skilled in the art, upon reading this specification, could very well consider part of the equipment marked as a separate embodiment. In other words, the embodiments in this specification can also be understood as the integration of multiple sub-embodiments. And each sub-embodiment is valid even when it includes fewer features than a single full embodiment disclosed above.

Each patent, patent application, publication of a patent application, and other materials, such as articles, books, specifications, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this specification. Other modified embodiments are also within the scope of this specification. Therefore, the embodiments disclosed in this specification are merely examples and not limitations. A person skilled in the art can adopt alternative configurations based on the embodiments in this specification to implement the application in this specification. Thus, the embodiments of this specification are not limited to the embodiments described in the application in precise detail.

What is claimed is:

1. An acoustic system, comprising:
a speaker, configured to receive an input signal and output a target sound during operation;
a sound sensor module, comprising at least a first sound sensor and a second sound sensor, wherein the first sound sensor collects an ambient sound and generates a first signal during operation, the second sound sensor collects the ambient sound and generates a second signal during operation, and the ambient sound comprises at least the target sound; and
a signal processing circuit, connected to the sound sensor module to execute, wherein during operation, the acoustic system performs:
obtaining a first signal,
obtaining a second signal,
performing a first target operation on the first signal and the second signal to reduce pickup of the target sound by the sound sensor module in a target frequency band and attenuate a signal corresponding to the target sound picked up by the sound sensor module, so as to obtain a target signal, and
performing a second target operation on the target signal.

2. The acoustic system according to claim 1, wherein the first target operation comprises:
a sound pickup control operation, directing a zero sound pickup direction of the sound sensor module in the target frequency band towards the speaker; and
an adaptive filtering operation, attenuating the signal corresponding to the target sound.

3. The acoustic system according to claim 2, wherein the sound pickup control operation is performed by a sound pickup control circuit in the signal processing circuit, and the adaptive filtering operation is performed by an adaptive filtering circuit in the signal processing circuit.

4. The acoustic system according to claim 2, wherein to perform the first target operation, the signal processing circuit executes:
performing the sound pickup control operation on the first signal and the second signal to obtain a sound pickup control output signal; and
obtaining an input signal of the speaker, and performing the adaptive filtering operation on the sound pickup control output signal based on the input signal to obtain the target signal.

5. The acoustic system according to claim 4, wherein the adaptive filtering operation comprises:
providing a target gain to the input signal to obtain a third signal, wherein the target gain corresponds to a transfer function between the speaker and the sound sensor module; and
subtracting the third signal from the sound pickup control output signal to obtain the target signal.

6. The acoustic system according to claim 2, wherein to perform the first target operation, the signal processing circuit executes:
obtaining an input signal of the speaker, and performing the adaptive filtering operation on the first signal and the second signal based on the input signal to obtain a first filtered signal corresponding to the first signal and a second filtered signal corresponding to the second signal; and
performing the sound pickup control operation on the first filtered signal and the second filtered signal to obtain the target signal.

7. The acoustic system according to claim 6, wherein the adaptive filtering operation comprises:
providing a first target gain to the input signal to obtain a fourth signal, and subtracting the fourth signal from the first signal to obtain a first filtered signal, wherein the first target gain corresponds to the transfer function between the speaker and the first sound sensor; and
providing a second target gain to the input signal to obtain a fifth signal, and subtracting the fifth signal from the second signal to obtain a second filtered signal, wherein the second target gain corresponds to the transfer function between the speaker and the second sound sensor.

8. The acoustic system according to claim 2, wherein the target frequency band corresponds to a sound pickup frequency band of the sound sensor module; and the sound pickup control operation comprises:
a zero differential operation, performing zero differential on a first individual signal and a second individual signal to adjust the zero sound pickup direction of the sound sensor module to point towards the speaker, thereby obtaining a differential result signal, wherein the first individual signal corresponds to a pickup signal of the first sound sensor, the second individual signal corresponds to a pickup signal of the second sound sensor, and the differential result signal serves as an output signal of the sound pickup control operation.

9. The acoustic system according to claim 2, wherein a sound pickup frequency band of the sound sensor module comprises a first frequency band and a second frequency band, and the target frequency band corresponds to the first frequency band; and
the sound pickup control operation comprises:
a zero differential operation to perform zero differential on a first individual signal and a second individual signal to adjust the zero sound pickup direction of the sound sensor module to point towards the speaker, thereby obtaining a differential result signal, wherein the first individual signal corresponds to a pickup signal of the first sound sensor, and the second individual signal corresponds to a pickup signal of the second sound sensor, and
a signal synthesis operation to synthesize the differential result signal and the first individual signal to obtain a composite signal, wherein the composite signal serves as an output signal of the sound pickup control operation, and a component of the first frequency band in the composite signal is derived from the differential result signal, while a component of the second frequency band is derived from the first individual signal.

10. The acoustic system according to claim 9, wherein the signal synthesis operation comprises:
performing a first filtering on the first individual signal to obtain the component of the second frequency band in the first individual signal;
performing a second filtering on the differential result signal to obtain the component of the first frequency band in the differential result signal; and
synthesizing the component of the first frequency band and the component of the second frequency band to obtain the composite signal.

11. The acoustic system according to claim 10, wherein the first filtering and the second filtering are complementary filtering.

12. The acoustic system according to claim 8, wherein the zero differential operation comprises:
a first delay operation to delay the second individual signal to obtain a second delayed signal;
a first differential operation to perform a differential operation on the first individual signal and the second delayed signal to obtain a first differential signal; and
a gain compensation operation to perform gain compensation on a signal of at least a portion of a frequency band in the first differential signal to obtain the differential result signal.

13. The acoustic system according to claim 8, wherein the zero differential operation comprises:
a first delay operation to delay the second individual signal to obtain a second delayed signal;
a second delay operation to delay the first individual signal to obtain a first delayed signal;
a first differential operation to perform a differential operation on the first individual signal and the second delayed signal to obtain a first differential signal;
a second differential operation to perform a differential operation on the second individual signal and the first delayed signal to obtain a second differential signal;
a third differential operation to perform a differential operation on the first differential signal and the second differential signal to obtain a third differential signal; and
a gain compensation operation to perform gain compensation on a signal of at least a portion of the frequency band in the third differential signal to obtain the differential result signal.

14. The acoustic system according to claim 13, wherein the zero differential operation further comprises:
a target parameter generation operation to generate a target parameter with so as to minimize a signal component from the speaker in the third differential signal; and
a multiplication operation to perform with the second differential operation and the third differential operation to multiply the target parameter with the second differential signal to obtain a multiplication result, so that the third differential operation performs a differential operation on the first differential signal and the multiplication result to obtain the third differential signal.

15. The acoustic system according to claim 1, wherein the second target operation comprises: performing gain amplification on the target signal and sending a gain-amplified signal to the speaker, so that the speaker emits the target sound.

16. The acoustic system according to claim 1, wherein the speaker and the sound sensor module are arranged on a first acoustic device, and the first acoustic device is in communication with a second acoustic device; and
the second target operation comprises: sending the target signal to the second acoustic device to reduce an echo of the second acoustic device.

17. The acoustic system according to claim 1, wherein the acoustic system is any one of a hearing aid system, an amplification system, a headset system, a telephone system, or a conference system.

18. The acoustic system according to claim 1, wherein the acoustic system is a hearing aid system, and the acoustic system further comprises a housing, the speaker, the sound sensor module and the signal processing circuit are arranged within the housing, wherein
when the acoustic system is worn on the user's head, a sound output end of the speaker faces the user's head, and a pickup end of at least one sound sensor in the sound sensor module is located on a side of the housing away from the user's head.

19. A signal processing method, comprising, by a signal processing circuit:
obtaining a first signal, wherein the first signal is obtained by a first sound sensor in a sound sensor module during operation to capture an ambient sound, the ambient sound at least comprises a target sound, and the target sound is a sound output by a speaker during operation;
obtaining a second signal, wherein the second signal is obtained by a second sound sensor in the sound sensor module during operation to capture the ambient sound;
performing a first target operation on the first signal and the second signal to reduce pickup of the target sound by the sound sensor module in a target frequency band and attenuate a signal corresponding to the target sound picked up by the sound sensor module, so as to obtain a target signal; and
performing a second target operation on the target signal.

20. The method according to claim 19, the first target operation comprises:
a sound pickup control operation, directing a zero sound pickup direction of the sound sensor module in the target frequency band towards the speaker; and
an adaptive filtering operation, attenuating the signal corresponding to the target sound.
